(19) United States
(12) Patent Application Publication
(10) Pub. No.: US 2005/0047517 A1
(43) Pub. Date: Mar. 3, 2005

(54) Adaptive modulation for multi-antenna transmissions with partial channel knowledge

(76) Inventors: Giannakis B. Georgios, Minnetonka, MN (US); Shengli Zhou, Ashford, CT (US)

Correspondence Address: SHUMAKER & SIEFFERT, P. A., 8425 SEASONS PARKWAY, SUITE 105, ST. PAUL, MN, 55125, US

(21) Appl. No.: 10/770,116

(22) Filed: Feb. 2, 2004

Related U.S. Application Data
(60) Provisional application No. 60/499,754, filed on Sep. 3, 2003.

(51) Int. Cl. H04L 1/02

(52) U.S. Cl. 375/267

(57) ABSTRACT

Adaptive modulation techniques for multi-antenna transmissions with partial channel knowledge are described. Initially, a transmitter is described that includes a two-dimensional beamformer where coded data streams are power loaded and transmitted along two orthogonal basis beams. The transmitter optimally adjusts the basis beams, the power allocation between two beams, and the signal constellation. A partial CSI model for orthogonal frequency division multiplexed (OFDM) transmissions over multi-input multi-output (MIMO) frequency selective fading channels is then described. In particular, an adaptive MIMO-OFDM transmitter is described in which the adaptive two-dimensional coder-beamformer is applied on each OFDM subcarrier, along with an adaptive power and bit loading scheme across the OFDM subcarriers.

This application claims priority from U.S. Provisional Application Ser. No. 60/499,754, filed Sep. 3, 2003, the entire content of which is incorporated herein by reference.

### STATEMENT REGARDING FEDERALLY SPONSORED RESEARCH OR DEVELOPMENT

This invention was made with Government support under Contract Nos. CCR-0105612, awarded by the National Science Foundation, and Contract No. DAAD19-01-2-0011 (Telcordia Technologies, Inc.) awarded by the U.S. Army. The Government may have certain rights in this invention.

### TECHNICAL FIELD

The invention relates to wireless communication and, more particularly, to coding techniques for multi-antenna transmitters.

### BACKGROUND

By matching transmitter parameters to time varying channel conditions, adaptive modulation can increase the transmission rate considerably, which justifies its popularity for future high-rate wireless applications. The adaptive modulation makes use of channel state information (CSI) at the transmitter, which may be obtained through a feedback channel. Adaptive designs assuming perfect CSI work well only when CSI imperfections induced by channel estimation errors and/or feedback delays are limited. For example, an adaptive system with delayed error-free feedback should maintain a feedback delay τ≦0.01/f_{d}, where f_{d} denotes the Doppler frequency. Such stringent constraint is hard to ensure in practice, unless channel fading is sufficiently slow. However, long range channel predictors relax this delay constraint considerably. An alternative approach is to account for CSI imperfections explicitly, when designing the adaptive modulator.

On the other hand, antenna diversity has been established as an effective fading counter measure for wireless applications. Due to size and cost limitations, mobile units can typically only afford one or two antennas, which motivates multiple transmit-antennas at the base station. With either perfect or partial CSI at the transmitter, the capacity and performance of multi-antenna transmissions can be further improved.

Adaptive modulation has the potential to increase the system throughput significantly by matching transmitter parameters to time-varying channel conditions. However, adaptive modulation schemes that rely on perfect channel state information (CSI) are sensitive to CSI imperfections induced by estimation errors and feedback delays.

Moreover as symbol rates increase in broadband wireless applications, the underlying Multi-Input Multi-Output (MIMO) channels exhibit strong frequency-selectivity. By transforming frequency-selective channels to an equivalent set of frequency-flat sub-channels, orthogonal frequency division multiplexing (OFDM) has emerged as an attractive transmission modality, because it comes with low-complexity (de)modulation, equalization, and decoding, to mitigate frequency-selective fading effects. One challenge for an adaptive MIMO-OFDM transmissions involves determining whether and what type of CSI can be made practically available to the transmitter in a wireless setting where fading channels are randomly varying.

### SUMMARY

In general, the invention is directed to adaptive modulation schemes for multi-antenna transmissions with partial channel knowledge. The techniques are first described in reference to single-carrier, flat-fading channels. The techniques are then extended to multi-carrier, frequency-fading channels.

In particular, a transmitter is described that includes a two-dimensional beamformer where Alamouti coded data streams are power loaded and transmitted along two orthogonal basis beams. The transmitter adjusts the basis beams, the power allocation between two beams, and the signal constellation, to improve, e.g., maximize, the system throughput while maintaining a prescribed bit error rate (BER). Adaptive trellis coded modulation may also be used to further increase the transmission rate.

The described adaptive multi-antenna modulation schemes are less sensitive to channel imperfections compared to single-antenna counterparts. In order to achieve the same transmission rate, an interesting tradeoff emerges between feedback quality and hardware complexity. As an example, the rate achieved by on transmit antenna when f_{d}τ<0.01 can be provided by two transmit antennas, but with a relaxed feedback delay f_{d}τ=0.1, representing an order of magnitude improvement.

Next, a partial CSI model for orthogonal frequency division multiplexed (OFDM) transmissions over multi-input multi-output (MIMO) frequency selective fading channels is described. In particular, this disclosure describes an adaptive MIMO-OFDM transmitter in which the adaptive two-dimensional coder-beamformer is applied on each OFDM subcarrier, along with an adaptive power and bit loading scheme across OFDM subcarriers. By making use of the available partial CSI at the transmitter, the transmission rate may be increased or maximized while guaranteeing a prescribed error performance under the constraint of fixed transmit-power. Numerical results confirm that the adaptive two-dimensional space-time coder-beamformer (with two basis beams as the two “strongest” eigenvectors of the channel's correlation matrix perceived at the transmitter) combined with adaptive OFDM (power and bit loaded with M-ary QAM constellations) improves the transmission rate considerably.

In one embodiment, the invention is directed to a wireless communication device comprising a constellation selector, a beamformer, and a plurality of transmit antennas. The constellation selector adaptively selects a signal constellation from a set of constellations based on channel state information for a wireless communication channel, wherein the constellation selector maps information bits of an outbound data stream to symbols drawn from the selected constellation to produce a stream of symbols. The beamformer generates a plurality of coded data streams from the stream of symbols. The plurality of transmit antennas output waveforms in accordance with the plurality of coded data streams.

In another embodiment, the invention is directed to a wireless communication device comprising a plurality of adaptive modulators that each comprises: (i) a constellation selector that adaptively selects a signal constellation from a set of constellations based on channel state information for a wireless communication channel, wherein the constellation selector maps the respective information bits to symbols drawn from the selected constellation to produce a stream of symbols, and (ii) a beamformer that generates a plurality of coded data streams from the stream of symbols. The wireless communication device further comprises a modulator to produce a multi-carrier output waveform in accordance with the plurality of coded data streams for transmission through the wireless communication channel.

In another embodiment, the invention is directed to a method comprising receiving channel state information for a wireless communication system, adaptively selecting a signal constellation from a set of constellations based on the channel state information, and coding signals for transmission by a multiple antenna transmitter based on the estimated channel information and the selected constellation.

In another embodiment, the invention is directed to a computer-readable medium comprising instructions. The instructions cause a programmable processor to receive channel state information for a wireless communication system, and select a signal constellation from a set of constellations based on the channel state information. The instructions further cause the processor to map information bits of an outbound data stream to symbols drawn from the selected constellation to produce a stream of symbols, and apply an eigen-beamformer to generate a plurality of coded data streams from the stream of symbols to produce a plurality of coded signals.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a graph that compares the exact bit error rates (BERs) evaluated against the approximate BERs for QAM constellations

FIG. 2 is a block diagram illustrating a wireless communication system with Nₜ transmit-and Nᵣ receive-antennas.

FIG. 3 is a block diagram illustrating a two-dimensional (2D) beamformer upon which the adaptive multi-antenna transmitter described herein is based.

FIG. 4 is a graphic that plots the optimal regions for different signal constellations

FIG. 5 is a graph that plots the simulated BER and the approximate BER

FIG. 6 is a graph that plots one possible error path in adaptive trellis code modulation for 8-state trellis codes.

FIG. 7 plots the rate achieved by the adaptive transmitter.

FIG. 8 is a plot that illustrates an achieved transmission rate for a system having a single receive antenna.

FIG. 9 is a plot that illustrates a tradeoff between feedback delay and hardware complexity.

FIG. 10 is a plot that illustrates an achieved rate improvement with trellis coded modulation (TCM).

FIG. 11 is a plot that illustrates an impact of receive diversity on the adaptive TCM techniques.

FIG. 12 is a block diagram depicting an equivalent discrete-time baseband model of an OFDM wireless communication system.

FIG. 13 is plot that illustrates certain thresholds.

FIG. 14 is a plot that illustrates a power loading snapshot for certain channel realizations.

FIG. 15 is a plot illustrating certain threshold distances.

FIG. 16 is a plot illustrating a bit loading snapshot for certain channel realizations.

FIGS. 17-19 are plots that illustrate certain rate comparisons.

### DETAILED DESCRIPTION

This disclosure first presents a unifying approximation to bit error rate (BER) for M-ary quadrature amplitude modulation (M-QAM). Gray mapping from bits to symbols is assumed. In order to facilitate adaptive modulation, approximate BERs, that are very simple to compute, are particularly attractive. In addition to square QAMs with M=2²ⁱ, rectangular QAMs with M=2²ⁱ⁺¹ are considered. For exemplary purposes, the disclosure focuses on rectangular QAMs that can be implemented with two independent pulse-amplitude-modulations (PAMs): one on the In-Phase branch with size \sqrt{2M}, and the other on the Quadrature-phase branch with size \sqrt{M/2}.

Consider a non-fading channel with additive white Gaussian noise (AWGN), having variance N₀/2 per real and imaginary dimension. For a constellation with average energy Eₛ, let d₀:=min(|s−s′|) be its minimum Euclidean distance. For each constellation, define a constant g as:

$$\begin{matrix}g = \frac{3}{2 ( M - 1 )} for square M \text{-} QAM & ( 1 ) \\ g = \frac{6}{5 M - 4} for rectangular M \text{-} QAM . & ( 2 )\end{matrix}$$

The symbol energy Eₛ is then related to d₀² through the identity:
d₀²=4gEₛ (3)

The following unifying BER approximation for all QAM constellations can be adopted:

$${P}_{b} \approx 0.2 exp ( - \frac{{d}_{0}^{2}}{4 N0} ) , \qquad ( 4 )$$

which can be re-expressed as:

$${P}_{b} \approx 0.2 exp ( - \frac{gEs}{N0} ) . \qquad ( 5 )$$

BPSK is a special case of rectangular QAM with M=2, corresponding to g=1. Hence, no special treatment is needed for BPSK. We next verify the approximate BER.

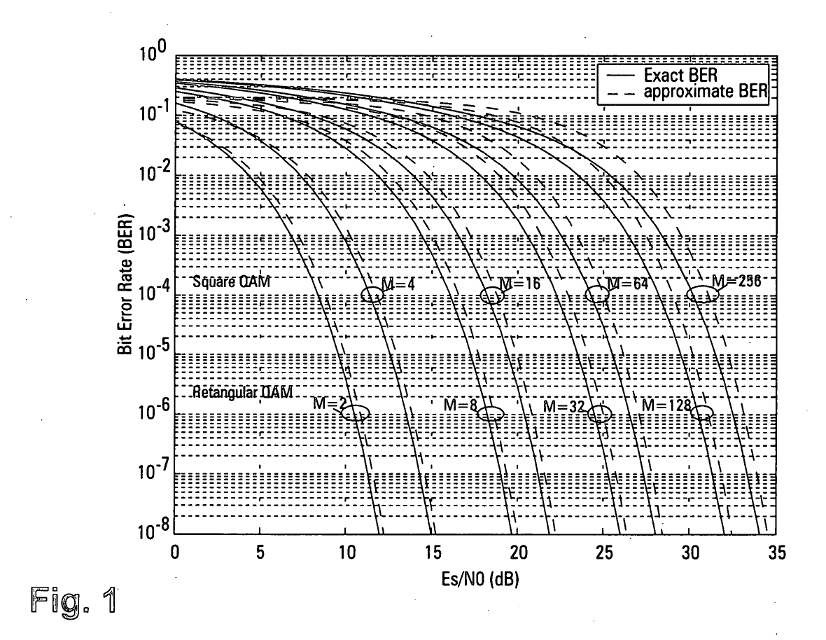

FIG. 1 is a graph that compares the exact BERs evaluated against the approximate BERs for QAM constellations with M=2ⁱ,i ε[1,8]. The approximation is within two dBs, for all constellations at P_{b}≦10⁻², as confirmed by FIG. 1.

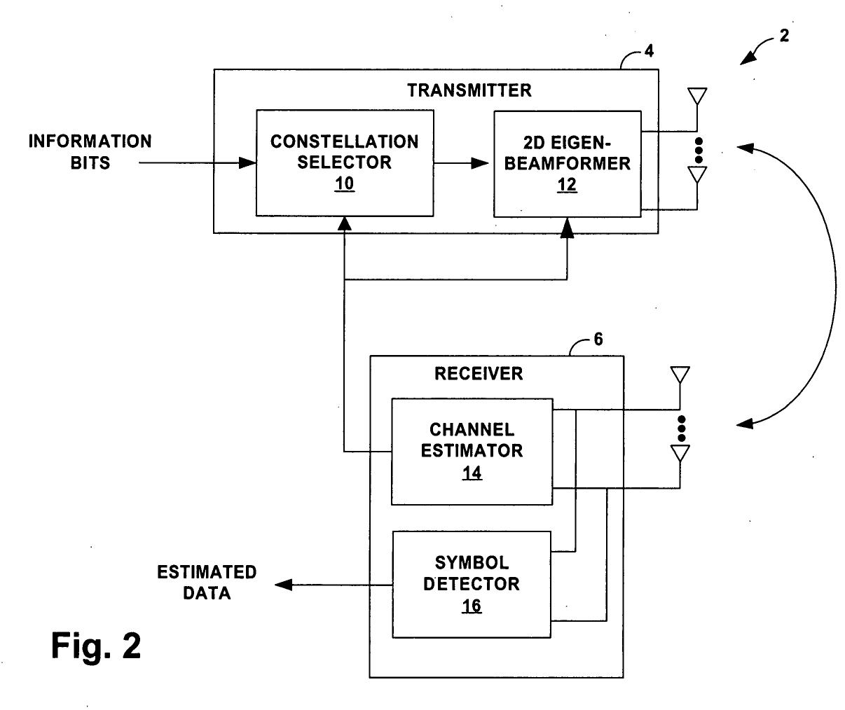

FIG. 2 is a block diagram illustrating a wireless communication system with Nₜ transmit-and Nᵣ receive-antennas. Focusing on flat fading channels, let h_{μv} denote the channel coefficient between the μth transmit- and the vth receive-antenna, where μ ε[1,Nₜ] and v ε[1,Nᵣ]. Channel coefficients may be collected in an Nₜ×Nᵣ channel matrix H having (μ, v)th entry h_{μv}. For each receive antenna v, the channel vector hᵥ:=[h₁ᵥ, . . . , h_{Ntv}]^{T} is defined.

The wireless channels are slowly time-varying. The receiver obtains instantaneous channel estimates, and feeds the channel estimates back to the transmitter regularly. Based on the available channel knowledge, the transmitter adjusts its transmission to improve the performance, and increase the overall system throughput. The disclosure next specifies an exemplary channel feedback setup, and develops an adaptive multi-antenna transmission structure.

Channel Mean Feedback

For exemplary purposes, the disclosure focuses on channel mean feedback, where spatial fading channels are modeled as Gaussian random variables with non-zero mean and white covariance conditioned on the feedback. Specifically, an assumption may be adopted that transmitter x models channels x as:
H=\overline{H}+Ξ, (6)
where \overline{H} is the conditional mean of H given feedback information, and ˜CN(0_{N}_{ₜ}_{×N}_{ᵣ}_{,}Nᵣσ_{E}²I_{N}_{ₜ}) is the associated zero-mean error matrix. The deterministic pair (\overline{H},σ_{ε}²) parameterizes the partial CSI, which is updated regularly given feedback information from the receiver.

The partial CSI parameters (\overline{H},σ_{ε}²) can be provided in many different ways. For illustration purposes, a specific application scenario with delayed channel feedback is explored and used in our simulations.

With regard to delayed channel feedback, it can be assumed that: i) the channel coefficients

$$\{ {h}_{μ v} \} {{N}_{t} {N}_{r}}_{μ = 1 , v = 1}$$

are independent and identically distributed with Gaussian distribution CN(0,σₕ²); ii) the channels are slowly time varying according to Jakes' model with Doppler frequency f_{d}; and iii) the channels are acquired perfectly at the receiver and are fed back to the transmitter with delay τ, but without errors. Perfect channel estimation at the receiver (with infinite quantization resolution), and error-free feedback, which can be approximated by using error-free control coding and ARQ protocol in feedback channel feedback H_{f} is drawn from the same Gaussian process as H, but in τ seconds ahead of H. The corresponding entries of H_{f} and H are then jointly zero-mean Gaussian, with correlation coefficient ρ:=J₀(2πf_{d}τ) specified from the Jakes' model, where J₀(•) is the zeroth order Bessel function of the first kind. For each realization of H_{f}, the parameters needed in the mean feedback model of (6) are obtained as:
\overline{H}=E{H|H_{f}}=ρH_{f, σ}_{E}²=σₕ²(1−|ρ|²). (7)
Adaptive Two Dimensional Transmit-Beamforming

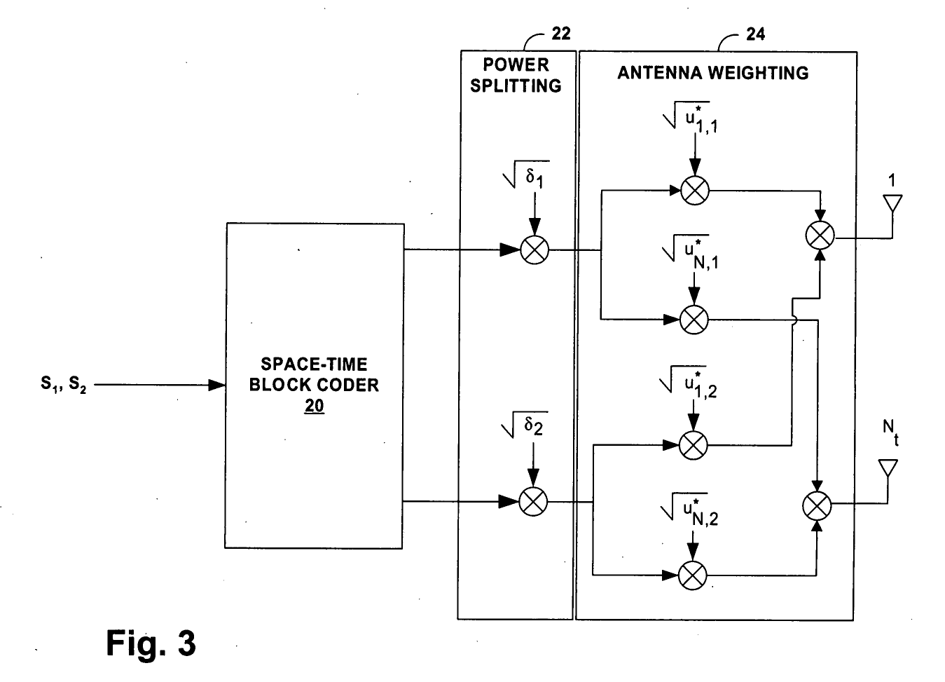

FIG. 3 is a block diagram illustrating a two-dimensional (2D) beamformer upon which the adaptive multi-antenna transmitter described herein is based. Depending on channel feedback, the information bits will be mapped to symbols drawn from a suitable constellation. The symbol stream s(n) will then be fed to the 2D beamformer, and transmitted through Nₜ antennas. The 2D beamformer uses the Alamouti code to generate two data streams \overline{s}₁(n) from the original symbol stream s(n) as follows:

$$[ \begin{matrix}{\overline{s}}_{1} ( 2 n ) & {\overline{s}}_{1} ( 2 n + 1 ) \\ {\overline{s}}_{2} ( 2 n ) & {\overline{s}}_{2} ( 2 n + 1 )\end{matrix} ] = [ \begin{matrix}s ( 2 n ) & - s * ( 2 n + 1 ) \\ s ( 2 n + 1 ) & s * ( 2 n )\end{matrix} ] . \qquad ( 8 )$$

The total transmission power Eₛ is allocated to these streams: δ₁Eₛ to \overline{s}₁(n), and δ₂Eₛ=(1−δ₁)Eₛ to \overline{s}₂ (n), where δ₁ ε [0,1]. Each power-loaded symbol stream is weighted by an Nₜ×1 beam-steering vector X(n):=[x₁(n), . . . ,x_{N}_{ₜ}(n)]^{T} at the nth time slot is:
X(n)=\overline{s}₁(n)\sqrt{δ₁}u₁^{*}+\overline{s}₂(n\sqrt{δ₂}u₂^{*}) (9)

Moving from single to multiple transmit-antennas, a number of spatial multiplexing and space time coding options are possible, at least when no CSI is available at the transmitter. An adaptive transmitter based on a 2D beamforming approach may be advantageous for a number of reasons.

For example, based on channel mean feedback, the optimal transmission strategy (in the uncoded case) is to combine beamforming (with Nₜ≧2 beams) with orthogonal space time block coding (STBC), where the optimality pertains to an upper-bound on the pairwise error probability, or an upper-bound on the symbol error rate. However, orthogonal STBC loses rate when Nₜ>2, which is not appealing for adaptive modulation whose ultimate goal is to increase the data rate given a target BER performance. On the other hand, the 2D beamformer can achieve the best possible performance when the channel feedback quality improves. Furthermore, the 2D beamformer is suboptimal only at very high SNR. In such cases, the achieved BER is already below the target, rendering further effort on BER improvement by sacrificing the rate unnecessary. In a nutshell, the 2D beamformer is preferred because of its full-rate property, and its robust performance across the practical SNR range.

In addition, the 2D beamformer structure is general enough to include existing adaptive multi-antenna approaches; e.g., the special case of (Nₜ, Nᵣ)=(2, 1) with perfect CSI considered. To verify this, the channels can be denoted as h₁ and h₂. Setting (δ₁, δ₂)=(1,0), u₁=[1,0]^{T} when |h₁|>|h₂| and u₁=[0,1]^{T} otherwise, our 2D beamformer reduces to the selective transmitter diversity (STD) scheme. Setting (δ₁, δ₂)=(1,0) and u₁=[h₁, h₂]^{T}/\sqrt{|h₁|²+|h₂|²} our 2D beamformer reduces to the transmit adaptive array (TxAA) scheme. Finally, setting (δ₁, δ₂)=(½, ½), u₁=[1,0]^{T} and u₂=[0,1]^{T} leads to the space time transmit diversity (STTD) scheme.

Moreover, due at least in part to the Alamouti structure, improved receiver processing can readily be achieved. The received symbol γᵥ(n) on the vth antenna is:

$$\begin{matrix}{y}_{v} ( n ) = {x}^{T} ( n ) {h}_{v} + {w}_{v} ( n ) \\ = \overline{{s}_{1}} ( n ) \sqrt{{δ}_{1}} {u}_{1}^{H} {h}_{v} + {\overline{s}}_{2} ( n ) \sqrt{{δ}_{2}} {u}_{2}^{H} {h}_{v} + {w}_{v} ( n ) ,\end{matrix} \qquad ( 10 )$$

where wᵥ(n) is the additive white noise with variance N₀/2 per real and imaginary dimension. Eq. (10) suggests that the receiver only observes two virtual transmit antennas, transmitting \overline{s}₁(n) and \overline{s}₂(n), respectively. The equivalent channel coefficient from the jth virtual transmit antenna to the vth receive-antenna is \sqrt{δⱼ}uⱼ^{H}hᵥ Supposing that the channels remain constant at least over two symbols, the linear maximum ratio combiner (MRC) is directly applicable to our receiver, ensuring maximum likelihood optimality. Symbol detection is performed separately for each symbol; and each symbol is equivalently passing through a scalar channel with

$$\begin{matrix}y ( n ) = {h}_{eqv} s ( n ) + w ( n ) . \\ {h}_{eqv} := {[ {δ}_{1} {\sum }_{v = 1}^{{N}_{r}} {\vert {u}_{1}^{H} {h}_{v} \vert}^{2} + {δ}_{2} {\sum }_{v = 1}^{{N}_{r}} {\vert {u}_{2}^{H} {h}_{v} \vert}^{2} ]}^{1 / 2} ,\end{matrix} \qquad ( 11 )$$

where w(n) has variance N₀/2 per dimension. The transmitter influences the quality of the equivalent scalar channel h_{eqv} through the 2D beamformer adaptation of (δ₁, δ₂, u₁, u₂).

As yet another advantage, the combination of Alamouti's coding and transmit-beamforming may be advantages in view of emerging standards.

Adaptive Modulation Based on 2D Beamforming

Returning to FIG. 2, based on mean feedback, transmitter 4 controls eigen-beamformer x to adjust the basis beams (u₁ and u₂), the power allocation (δ₁ and δ₂), and the signal constellation of size M and energy Eₛ, to maximize the transmission rate while maintaining the target BER:P_{b,target}. For purposes of illustration, QAM constellations are adopted, N different QAM constellations with Mᵢ=2ⁱ, where i=1, 2, . . . , N, as those exemplified above, are assumed. Correspondingly, the constellation-specific constant g can be denoted as gᵢ. The value of gᵢ is evaluated from (1), or (2), depending on the constellation Mᵢ. When the channel experiences deep fades, the adaptive design may be allowed to suspend data transmission (this will correspond to M₀=0).

Under these assumptions, transmitter 4 perceives a random channel matrix H as in (6). The BER for each realization of H is obtained from (11) and (5) as:

$${P}_{b} ( H , {M}_{i} ) \approx 0.2 exp ( - {h}_{eqv}^{2} \frac{{g}_{i} {E}_{s}}{{N}_{0}} ) \qquad ( 12 )$$

Since the realization of H is not available, the transmitter relies on the average BER:

$${\overline{P}}_{b} ( {M}_{i} ) = E \{ {P}_{b} ( H , {M}_{i} ) \} \approx 0.2 E \{ exp ( - {h}_{eqv}^{2} \frac{{g}_{i} {E}_{s}}{{N}_{0}} ) \} , \qquad ( 13 )$$

and uses \overline{P}_{b}(Mᵢ) as a performance metric to select a constellation of size Mᵢ.

Let the eigen decomposition of \overline{HH}^{H} be:
\overline{HH}^{H}=U_{H}D_{H}U_{H}^{H}, D_{H}:=diag(λ₁, λ₂, . . . , λ_{Nt}) (14)
where U_{H}:=└u_{H,1}, . . . , u_{H,N}_{ₜ}┘ contains Nₜ eigenvectors, and D_{H} has the corresponding Nₜ eigenvalues on its diagonal in a non-increasing order λ₁≧λ₂≧ . . . ≧λ_{N}_{ₜ}. Because {u_{H,μ}}_{μ=1}^{N}^{ₜ} are also eigenvectors of \overline{HH}^{H}+Nᵣσ_{ε}²I_{N}_{ₜ} the correlation matrix of the perceived channel H in (6), we term them as eigen-directions, or, eigen-beams.

For any power allocation with δ₁≧δ₂≧0 the optimal u₁ and u₂ minimizing \overline{P}_{b}(Mᵢ) can be expressed as:
u₁=u_{H,1}, u₂=u_{H,2} (15)
In other words, the optimal basis beams for our 2D beamformer are eigen-beams corresponding to the two largest eigenvalues λ₁ and λ₂. Hereinafter, the adaptive 2D beamformer is referred to as a 2D eigen-beamformer.
Adaptive Power Allocation between Two Beams

With the optimal eigen-beams, the average BER can be obtained similarly, but with only two virtual antennas. Formally, the expected BER is:

$${\overline{P}}_{b} ( {M}_{i} ) \approx 0.2 {\prod }_{μ = 1}^{2} {[ \frac{1}{1 + {δ}_{μ} {β}_{i}} exp ( - \frac{{λ}_{μ} {δ}_{μ} {β}_{μ}}{{N}_{r} {σ}_{ɛ}^{2} ( 1 + {δ}_{μ} {β}_{i} )} ) ]}^{{N}_{r}} \qquad ( 16 )$$

where for notational brevity, we define
βᵢ:=gᵢσ_{ε}²Eₛ/N₀ (17)
For a given βᵢ, the optimal power allocation that minimizes (16) can be found in closed-form, following derivations. Specifically, with two virtual antennas, we simplify to:
δ₂=max(δ₂⁰,0), δ₁=1−δ₂ (18)
where δ₂⁰ is obtained from:

$${δ}_{2}^{0} := \frac{1 + \frac{{N}_{r} {σ}_{ɛ}^{2} + {λ}_{1}}{( {N}_{r} {σ}_{ɛ}^{2} + 2 {λ}_{1} ) {β}_{i}}}{1 + \frac{( {N}_{r} {σ}_{ɛ}^{2} + 2 {λ}_{2} ) {( {N}_{r} {σ}_{ɛ}^{2} + {λ}_{1} )}^{2}}{( {N}_{r} {σ}_{ɛ}^{2} + 2 {λ}_{1} ) {( {N}_{r} {σ}_{ɛ}^{2} + {λ}_{2} )}^{2}}} - \frac{{N}_{r} {σ}_{ɛ}^{2} + {λ}_{2}}{( {N}_{r} {σ}_{ɛ}^{2} + 2 {λ}_{2} ) {β}_{i}} \qquad ( 19 )$$

The optimal solution guarantees that δ₁≧δ₂≧0; thus, more power is allocated to the stronger eigen-beam. If two eigen-beams are equally important (λ₁=λ₂), the optimal solution is δ₁=δ₂=½. On the other hand, if the channel feedback quality improves as σ_{ε}²→0,δ₁ and δ₂ are constellation dependent.
Adaptive Rate Selection with Constant Power

With perfect CSI, using the probability density function (p.d.f.) of the channel fading amplitude, the optimal rate and power allocation for single antenna transmissions has been provided. Optimal rate and power allocation for the multi-antenna transmission described herein with imperfect CSI turns out to be much more complicated. Constant power transmission can be, therefore, focused on, and only the modulation level is adjusted. Constant power transmission simplifies the transmitter design, and obviates the need for knowing the channel p.d.f.

With fixed transmission power and a given constellation, transmitter 4 computes the expected BER with optimal power splitting in two eigen-beans, per channel feedback. The transmitter then chooses the rate-maximizing constellation, while maintaining the target BER. Since the BER performance decreases monotonically with the constellation size, the transmitter finds the optimal constellation to be:
M=arg max \overline{P}b(M)≦P_{b,target} (20)
ME{Mᵢ}ᵢ₌₀^{N}
This equation can be solved by trial and error; starting with the largest constellation Mᵢ=M_{N}, and then decreasing i until the optimal Mᵢ is found.

Although there are NₜNᵣ entries in H, constellation selection depends only on the first two eigen-values λ₁ and λ₂. The two dimensional space of (λ₁,λ₂) can be split in N+1 disjoint regions {Dᵢ}ᵢ₌₀^{N} each associated with one constellation. Specifically,
M=Mᵢ, when (λ₁,λ₂)εDᵢ, ∀i=0,1, . . . , N (21)
can be chosen. The rate achieved by system 2 of FIG. 2 is therefore

$$R = {\sum }_{i = 1}^{N} {log}_{2} ( {M}_{i} ) \int {\int }_{{D}_{i}} p ( {λ}_{1} , {λ}_{2} ) ⅆ {λ}_{1} ⅆ {λ}_{2} , \qquad ( 22 )$$

where p(λ₁, λ₂) is the joint p.d.f. of λ₁ and λ₂. The outage probability is thus:
Pₒᵤₜ=∫∫_{D}_{₀}p(λ₁, λ₂)dλ₁dλ₂. (23)
The fading regions can be specified. Since λ₂=λ₁, we have a:=λ₂/λ₁ε[0,1] To specify the region Dᵢ in the (λ₁, λ₂) space, the intersection of Dᵢ with each straight line can be specified as λ₂=aλ₁ where a ε[0,1]. Specifically, the fading region Dᵢ on each line will reduce to an interval. This interval on the line λ₂=aλ₁ will be denoted as [αᵢ(α),α+1(α)), during which the constellation Mᵢ is chosen. In addition, α₀(α)=0 and α_{N+1}(a)=∞. The boundary points {αᵢ(α)}ᵢ₌₁^{N} remain to be specified.

For a given constellation Mᵢ and power allocation factors (δ₁,δ₂=1−δ₁) the minimum value of λ₁ on the line of λ₂=aλ₁ can be determined so that \overline{P}_{b}(Mᵢ)≦P_{b,target} as:

$$\begin{matrix}{λ}_{1} ( a , {δ}_{1} {M}_{i} ) = {{σ}_{ɛ}^{2} ( \frac{{δ}_{1} {β}_{i}}{1 + {δ}_{1} {β}_{i}} + \frac{a {δ}_{2} {β}_{i}}{1 + {δ}_{2} {β}_{i}} )}^{- 1} \times \\ in ( \frac{0.2}{{{P}_{b , target} [ ( 1 + {δ}_{1} {β}_{i} ) ( 1 + {δ}_{2} {β}_{i} ) ]}^{{N}_{r}}} )\end{matrix} \qquad ( 24 )$$

Since the optimal δ₁ε[½,1]will lead to the minimal λ₁ that satisfies the BER requirement, the boundary point αᵢ(a) can be found as:

$${α}_{i} ( a ) = {min}_{{δ}_{1} ∈ [ 1 / 2 , 1 ]} {λ}_{1} ( a , {δ}_{1} , {M}_{i} ) \qquad ( 25 )$$

The minimization is a one-dimensional search, and it can be carried out numerically. Having specified the boundaries on each line, the fading regions associated with each constellation in the two dimensional space can be plotted, as illustrate in further detail below.

In the general multi-input multi-output (MIMO) case, each constellation Mᵢ is associated with a fading region Dᵢ on the two dimensional plane (λ₁, λ₂). Several special cases exist, where the fading region is effectively determined by fading intervals on the first eigenvalue λ₁. In such cases, the boundary points are denoted as {\overline{α}ᵢ}ₜ₌₀^{N+1}. The constellation Mᵢ is chosen when λ₁ε[\overline{α}ᵢ,\overline{α}ᵢ₊₁) The following may then be obtained:

$$\begin{matrix}R = {\sum }_{i = 1}^{N} {log}_{2} ( {M}_{i} ) {\int }_{{\overline{α}}_{i}}^{{\overline{α}}_{i} + 1} p ( {λ}_{1} ) ⅆ {λ}_{1} \\ = {\sum }_{i = 1}^{N} {log}_{2} ( {M}_{i} ) [ F ( {\overline{α}}_{i + 1} ) - F ( {\overline{α}}_{i} ) ]\end{matrix} \qquad ( 26 )$$

where F(x):=∫₀^{x}p(λ₁)dλ₁ is the cumulative distribution function (c.d.f.) of λ₁. The outage becomes:
Pₒᵤₜ=F(\overline{α}₁) (27)
To calculate the rate and outage, it suffices to determine the p.d.f. of λ₁, and the boundaries {\overline{α}ᵢ}ᵢ₌₁^{N}. For multiple transmit—and a single receive—antennas, Nᵣ=1, and there is only one non-zero eigen-value λ₁, and thus a=λ₂/λ₁=0. The boundary points are:
\overline{α}ᵢ=αᵢ(0) ∀i=0,1, . . . , N (28)
where αᵢ(a) is specified in (25).

When Nᵣ=1, the channel h₁ is distributed as CN(0,I_{N}_{ₜ}). With delayed feedback considered in Example 2, we have

$${λ}_{1} = ( {\vert ρ \vert}^{2} ) {‖ {h}_{1} ‖}^{2} = {\vert ρ \vert}^{2} {\sum }_{μ = 1}^{{N}_{t}} {\vert {h}_{μ1} \vert}^{2}$$

which is Gamma distributed with parameter Nₜ and mean E{λ₁}=|ρ|²Nₜ The p.d.f. and c.d.f. of λ₁ are:

$$\begin{matrix}p ( {λ}_{1} ) = {( \frac{1}{{\vert ρ \vert}^{2}} )}^{{N}_{t}} \frac{{λ}_{1}^{{N}_{t} - 1}}{( {N}_{t} - 1 ) !} exp ( - \frac{{λ}_{1}}{{\vert ρ \vert}^{2}} ) , {λ}_{1} \geq 0 & ( 29 ) \\ \begin{matrix}F ( χ ) = {\int }_{0}^{χ} p ( {λ}_{1} ) ⅆ {λ}_{1} \\ = 1 - {ⅇ}^{- χ / {\vert ρ \vert}^{2}} {\sum }_{j = 0}^{{N}_{t} - 1} \frac{1}{j !} {( \frac{χ}{{\vert ρ \vert}^{2}} )}^{j} , χ \geq 0\end{matrix} & ( 30 )\end{matrix}$$

Plugging (30) and (28) into (26), the rate becomes readily available.

Turning to the MIMO case, the adaptive 2D beamformer described herein subsumes a 1D beamformer by setting δ₁=1 and δ₂=0. Numerical search is now unnecessary, and δ₂=0 does not depend on a anymore. The following can be simplified:

$$\begin{matrix}{\overline{α}}_{i} = {λ}_{1} ( a , 1 , {M}_{i} ) \\ = \frac{{σ}_{∈}^{2}}{{β}_{i}} ( 1 + {β}_{i} ) in ( \frac{0.2}{{{P}_{b , target} ( 1 + {β}_{i} )}^{{N}_{t}}} )\end{matrix} \qquad ( 31 )$$

The fading region thus depends only on λ₁.

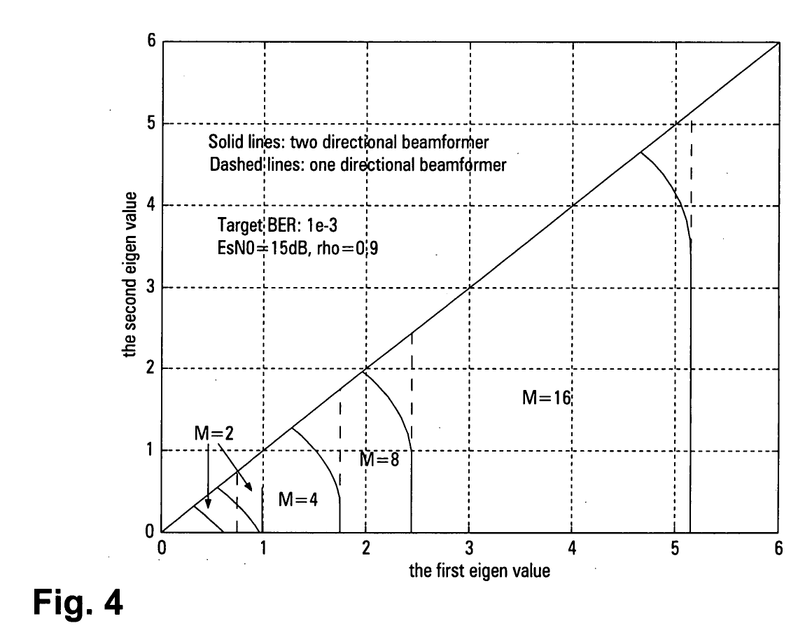

FIG. 4 is a graphic that plots the optimal regions for different signal constellations with P_{b}=10⁻³, Eₛ/N₀=15 dB and ρ=0.9. As the constellation size increases, the difference between 1D and 2D beamforming decreases.

With perfect CSI (σ_{ε}²=0.\overline{H}=H) the optimal loading ends up being δ₁=1, δ₂=0. Therefore, the optimal transmission strategy in this case is 1D eigen-beamforming. The results apply to 1D beamforming, but with σ_{ε}²=0 Specifically, we simplify to

$$\begin{matrix}{P}_{b} ( {M}_{i} ) \approx 0.2 exp ( - {λ}_{1} \frac{{g}_{i} {E}_{s}}{{N}_{0}} ) and to & ( 32 ) \\ {\overline{α}}_{i} = {λ}_{1} ( a , 1 , {M}_{1} ) = \frac{1}{{g}_{i} {E}_{s} / {N}_{0}} in ( \frac{0.2}{{P}_{b , target}} ) . & ( 33 )\end{matrix}$$

Eq. (32) reveals that the MIMO antenna gain is introduced solely through λ₁, the maximum eigenvalue of (or, HH^{H})

Notice that with perfect CSI, one can enhance spectral efficiency by adaptively transmitting parallel data streams over as many as Nₜ eigen-channels of. These data streams can be decoded separately at the receiver. However, this scheme can not be applied when the available CSI is imperfect, since the eigen-directions of \overline{HH}^{H} are no longer the eigen-directions of the true channel HH^{H}. As a result, these parallel streams will be coupled at the receiver side, and will interfere with each other. This coupling calls for higher receiver complexity to perform joint detection, and also complicates the transmitter design, since no approximate BER expressions are readily available.

Adaptive Trellis Coded Modulation

Next, coded modulation is considered. Recall that each information symbol s(n) is equivalently passing through a scalar channel in the proposed transmitter. Thus, conventional channel coding can be applied. For exemplary purpose, trellis coded modulation (TCM) is focused on, where a fixed trellis code is superimposed on uncoded adaptive modulation for fading channels. The single antenna design with perfect CSI can be extended to the MIMO system described herein with partial, i.e., imperfect, CSI.

For adaptive trellis coded modulation, out of n information bits, k bits pass through a trellis encoder to generate k+r coded bits. A constellation of size 2^{n+r} is partitioned into 2^{k+r} subsets with size 2^{n-k} each. The k+r coded bits specify which subset to be used, and the remaining n−k uncoded bits specify one signal point from the subset to be transmitted. The trellis code may be fixed, and the signal constellation may be adapted according to channel conditions. Different from the uncoded case, the minimum constellation size now is 2^{k+r} with each subset containing only one point. With a constellation of size Mᵢ, only log2(Mᵢ)−r bits are transmitted.

BER Approximation for AWGN Channels

Let d_{free} denote the minimum Euclidean distance between any pair of valid codewords. At high SNR, the error probability resulting from nearest neighbor codewords dominates. The dominant error events have probability:

$$\begin{matrix}{P}_{E} \approx N ( {d}_{free} ) Q ( \sqrt{\frac{{d}_{free}^{2}}{2 {N}_{0}}} ) \\ \approx 0.5 N ( {d}_{free} ) exp ( - \frac{{d}_{free}^{2}}{4 {N}_{0}} )\end{matrix} \qquad ( 34 )$$

where N(d_{free}) is the number of nearest neighbor codewords with Euclidean distance d_{free}. Along with (4) for the uncoded case, the BER can be approximated by:

$${P}_{b , TCM} \approx {c}_{2} {P}_{E} \approx {c}_{3} exp ( - \frac{{d}_{free}^{2}}{4 {N}_{0}} ) \qquad ( 35 )$$

where the constants c₂ and C₃ need to be determined. For each chosen trellis code, one constant C₃ may be used for all possible constellations to facilitate the adaptive modulation process.

For each chosen trellis code and signal constellation Mᵢ, the ratio of d_{free}²/d₀² is fixed. For each prescribed trellis code, we define:

$${g}_{i}^{′} = \frac{{d}_{free}^{2}}{{d}_{0}^{2}} {g}_{i} , for the constellation {M}_{i} . \qquad ( 36 )$$

Substituting (36) and (3) into (35), the approximate BER for constellation Mᵢ can be obtained as:

$${P}_{b , TCM} ( {M}_{i} ) \approx {c}_{3} exp ( - \frac{{g}_{i}^{′} {E}_{s}}{{N}_{0}} ) \qquad ( 37 )$$

The four-state trellis code can be checked with k=r=1. The constellations of size Mᵢ=2ⁱ, ∀i ε[2,8] are divided into four subsets, following the set partitioning procedure. Let dⱼ denote the minimum distance after the jth set partitioning. For QAM constellations, we have dⱼ₊₁/dⱼ=\sqrt{2}. When M>4, parallel transitions dominate with d_{free}²=d₂²=4d₀². With M=4, no parallel transition exists, and we have d_{free}²=d₀²+2d₁²=5d₀². We find the parameter c₃=1.5=0.375 N(d_{free}) for the four-state trellis, where N(d_{free})=4.

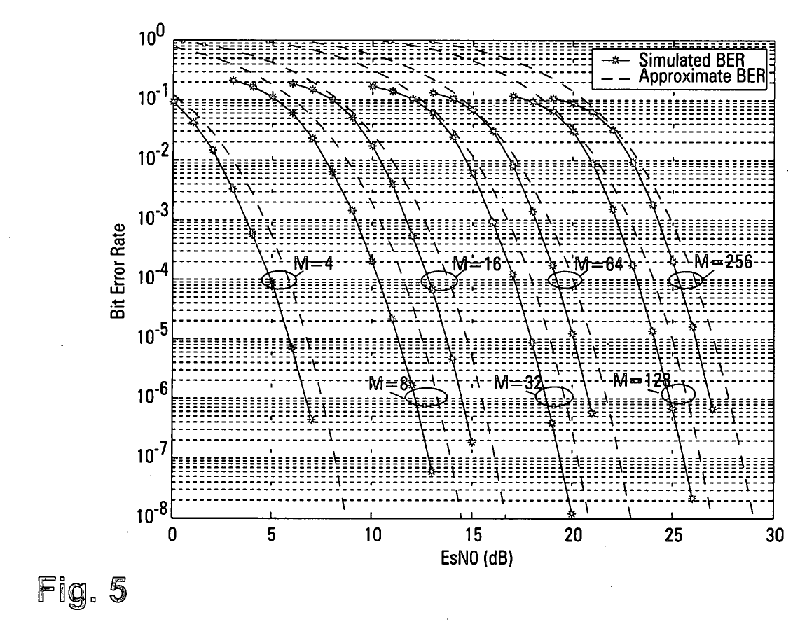

FIG. 5 is a graph that plots the simulated BER and the approximate BER in (37). The approximation is within 2 dB for BER less than 10⁻¹.

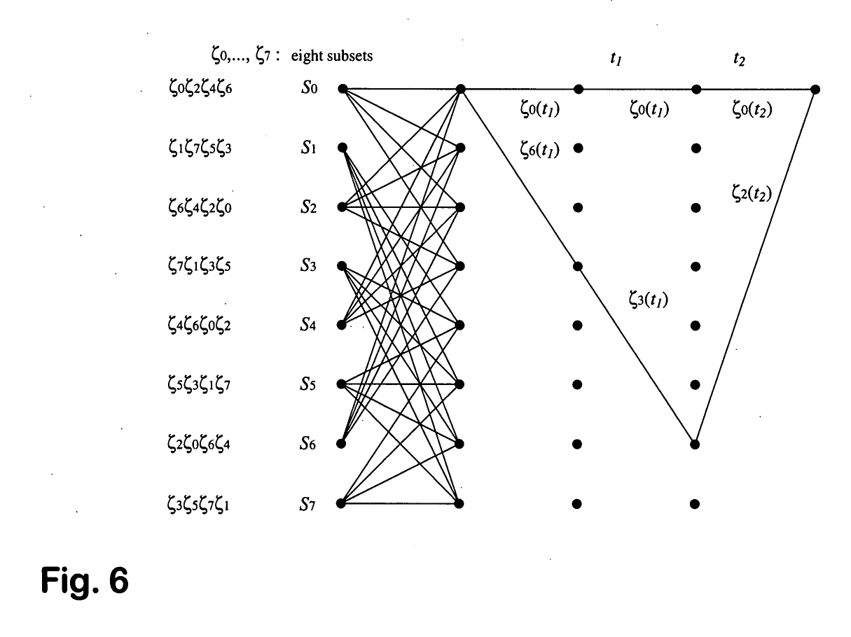

FIG. 6 is a graph that plots the trellis for the eight-state trellis code, which may also be checked with k=2 and r=1. The constellations of size M=2ⁱ, ∀iε are divided into eight subsets. The subset sequences dominate the error performance with d_{free}²=d₀²+sd₁²=5d₀² for all constellations. We choose c₃=6=0.375N(d_{free}) for the eight-state trellis code, where N(d_{free})=16. The approximation is within 2 dB for BER less than 10⁻

Adaptive TCM for Fading Channels

The adaptive coded modulation with mean feedback may now be specified. Since the transmitted symbols are correlated in time, a time index t is explicitly associated for each variable e.g., H(t) is used to denote the channel perceived at time t. The following average error probability at time t can be calculated based on (11) and (37):

$$\begin{matrix}{\overline{P}}_{b , TCM} ( {M}_{i} , t ) = E \{ {P}_{b , TCM} ( H ( t ) , {M}_{i} ) \} \\ \approx {c}_{3} E \{ exp ( - {h}_{eqv}^{2} ( t ) \frac{{g}_{i}^{′} {E}_{s}}{{N}_{0}} ) \} .\end{matrix} \qquad ( 38 )$$

At each time t when updated feedback arrives, transmitter 4 automatically selects the constellation:

$$M ( t ) = {arg max}_{M ∈ {\{ {M}_{i} \}}_{i = k + r}^{N}} {\overline{P}}_{b , TCM} ( M , t ) \leq {P}_{b , target} \qquad ( 39 )$$

By the similarity of (37) and (5), we end up with an uncoded problem with constellation M, having a modified constant gᵢ and conveying log₂(Mᵢ)−r bits.

However, distinct from uncoded modulation, the coded transmitted symbols are correlated in time. Suppose that the channel feedback is frequent. The subset sequences may span multiple feedback updates, and thus different portions of one subset sequence may use subsets partitioned from different constellations. The transmitter design in (39) implicitly assumes that all dominating error events are confined within one feedback interval. Nevertheless, this design guarantees the target BER for all possible scenarios. Since the dominating error events may occur between parallel transitions, or between subset sequences, this disclosure explores all of the possibilities:
1) Parallel transitions dominate: The parallel transitions occur in one symbol interval, and thus depend only on one constellation selection. The transmitter adaptation in (39) is in effect.
2) Subset sequences dominate: The dominating error events may be limited to one feedback interval, or, may span multiple feedback intervals. If the dominating error events are within one feedback interval, the transmitter adaptation in (39) is certainly effective. On the other hand, the error path may span multiple feedback intervals, with different portions of the error path using subsets partitioned from different constellations.

We focus on any pair of subset sequences c₁ and c₂. For brevity, it is assumed that the error path spans two feedback intervals (or updates), at time t₁ and t₂. Different constellations are chosen at time t₁ and t₂, resulting in different d₀² (t₁) and d₀²(t₂) As illustrated in FIG. 6, the distance between c₁ and c₂ can be partitioned as: d² (c₁,c₂|t₁,t₂)=d²(t₁)+d²(t₂) The contribution of d² (t₁) at time t₁ is the minimum distance between subsets ζ₀(t₁) and ζ₂(t₁) plus the minimum distance between subsets ζ₀(t₁) and ζ₃(t₁),i.e., d² (t₁)=d₁²(t₁)+d₀²(t₁)=3d₀²(t₁). Similarly, we have d²(t₂)=d₁²(t₂)=2d₀²(t₂)

Now, two virtual events can be constructed that the error path between c₁ and c₂ experiences only on feedback: One at t₁ and the other at t₂. For j=1,2, the average pairwise error probability is defined as:

$$\overline{P} ( {c}_{1} \to {c}_{2} \vert {t}_{i} ) = 0.5 E \{ exp ( - \frac{{h}_{eqv}^{2} ( {t}_{j} ) {d}^{2} ( {c}_{1} , {c}_{2} \vert {t}_{j} )}{} ) \} \qquad ( 40 )$$

Next, the following constants are defined:

$$\begin{matrix}{b}_{1} := \frac{\tilde{d} ( {t}_{1} )}{{{d}^{2} ( {c}_{1} , {c}_{2} \vert {t}_{1} )}^{′}} & {b}_{2} := \frac{\tilde{d} ( {t}_{2} )}{{d}^{2} ( {c}_{1} , {c}_{2} \vert {t}_{2} )}\end{matrix} \qquad ( 41 )$$

It is clear that b₁+b₂=1, and 0<b₁,b₂≦1.

When the error path between c1 and c2 spans multiple feedback intervals, the average PEP decreases relative to the case of one feedback interval. Since the conditional channels at different times are independent,

$$\begin{matrix}E \{ P ( {c}_{1} \to {c}_{2} \vert {t}_{1} , {t}_{2} ) \} = 0.5 E \{ exp ( - \frac{{h}_{eqv}^{2} ( {t}_{1} ) {\tilde{d}}^{2} ( {t}_{1} )}{4 {N}_{0}} ) \} \times \\ E \{ exp ( \frac{- {h}_{eqv}^{2} ( {t}_{2} ) {\tilde{d}}^{2} ( {t}_{2} )}{4 {N}_{0}} ) \} \\ \leq {{0.5 [ \frac{\overline{P} ( {c}_{1} \to {c}_{2} \vert {t}_{1} )}{0.5} ]}^{{b}_{1}} [ \frac{\overline{P} ( {c}_{1} \to {c}_{2} \vert {t}_{2} )}{0.5} ]}^{{b}_{2}} \\ \leq max ( \overline{P} ( {c}_{1} \to {c}_{2} \vert {t}_{1} ) , \overline{P} ( {c}_{1} \to {c}_{2} \vert {t}_{2} ) )\end{matrix} \qquad ( 42 )$$

where in deriving (42), the inequality in (47) (proved below) is used. Eq. (42) reveals that the worst case happens when the error path between subset sequences spans only on feedback. In such cases, however, we have guaranteed the average BER in (39), for each of the feedback intervals, the average pairwise error probability decreases, and thus the average BER (proportional to the dominating pairwise error probability is approximated in (35)) is guaranteed to stay below the target.

In summary, the transmitter adaptation in (39) guarantees the prescribed BER. With perfect CSI, this adaptation reduces to a point where d₀ is maintained for each constellation choice. The techniques described herein are simpler in comparison to some conventional approaches in the sense that the described techniques do not need to check all distances between each pair of subsets.

### EXAMPLES

In simulation purposes, the channel setup is adopted with σₕ²=1. Recall that the feedback quality σ_{ε}² is related to the correlation coefficient J₀(2πf_{d}τ) via σ_{ε}²=1−|ρ|². With ρ=0.95,0.9,0.8, we have σ_{ε}²=−10.1,−7.2,−4,4 dB. For fair comparison among different setups, the average received SNR is used in all plots and defined as:

averageSNR:=(1−Pₒᵤₜ)Eₛ/N₀ (43)

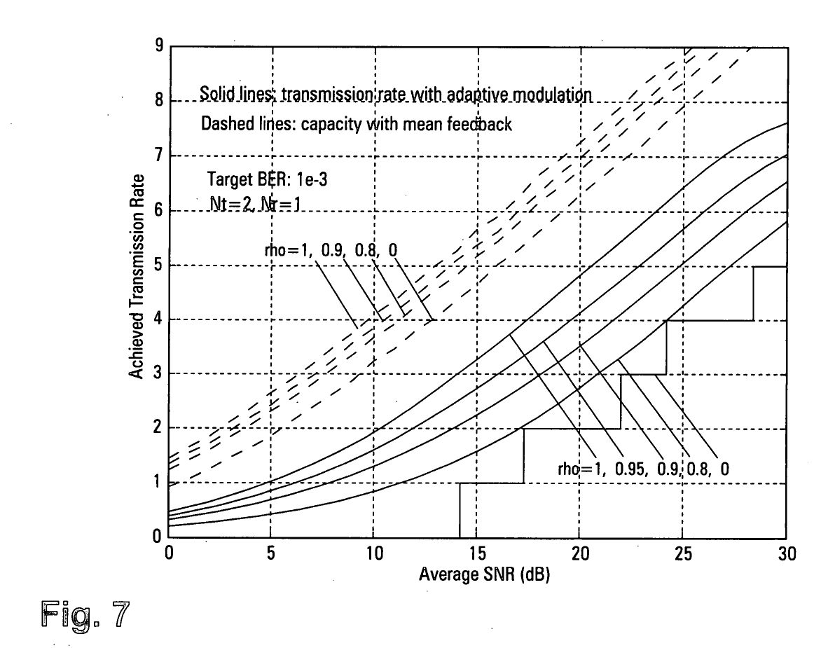

FIG. 7 plots the rate achieved by the adaptive transmitter 4 with P_{b,target}=10⁻³, Nₜ=2, Nᵣ=1, and ρ=1, 0.95, 0.9, 0.8, 0. As illustrated in FIG. 7, it is clear that the rate decreases relatively fast as the feedback quality drops.

For comparison, FIG. 7 also plots the channel capacity with mean feedback, using the semi-analytical result. As shown in FIG. 7, the capacity is less sensitive to channel imperfections. The capacity with perfect CSI is larger than the capacity with no CSI by about log₂(Nₜ)=1 bit at high SNR, as predicted. With ρ=0.9, the adaptive uncoded modulation is about 11 dB away from capacity.

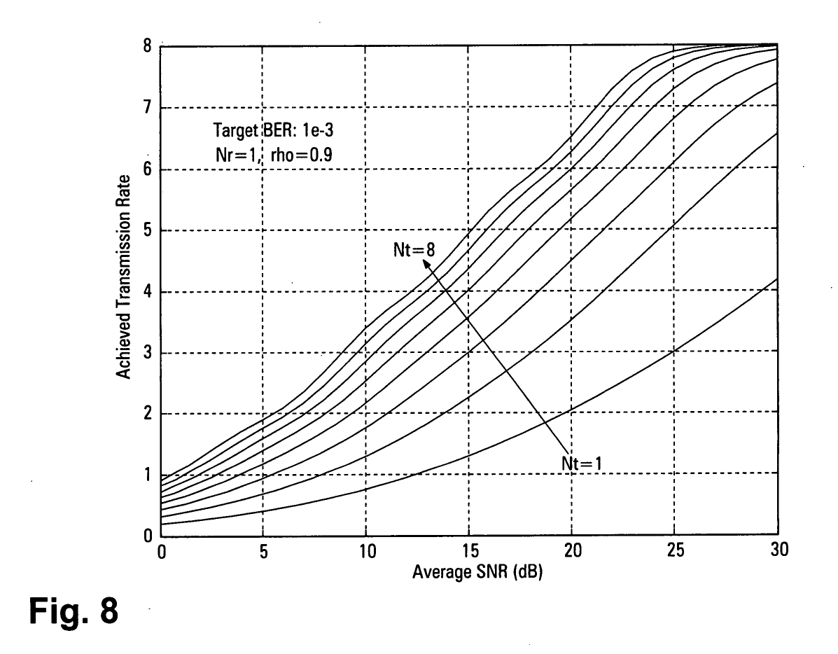

FIG. 8 is a plot that illustrates the achieved transmission rate with Nr=1, P_{b,target}=10⁻³, and ρ=0.9. As shown in FIG. 8, the achieved transmission rate increases as the number of transmit antennas increases. The largest rate improvement occurs when Nₜ increases from one to two.

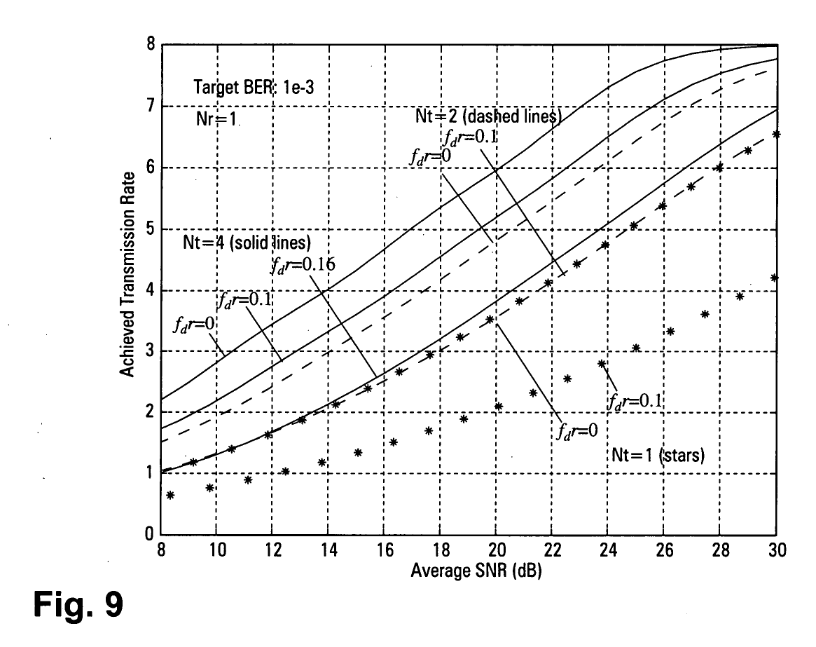

FIG. 9 is a plot that illustrates the tradeoff between feedback delay and hardware complexity. As illustrated, one tradeoff value is f_{d}T=0.01 for single antenna transmissions. FIG. 9, verifies that with two transmit antennas, the achieved rate with f_{d}T=0.1 (ρ=0.904) coincides with that corresponding to one transmit antenna with perfect CSI (f_{d}T≦0.01); hence, more than ten times of feedback delay can be tolerated. The rate with Nₜ=4 and f_{d}T=0.16 (p=0.76) is even better than that of Nₜ=1 with perfect CSI. To achieve the same rate, the delay constraint with single antenna can be relaxed considerably by using more transit antennas, an interesting tradeoff between feedback quality and hardware complexity. FIG. 9 also reveals that the adaptive deign becomes less sensitive to CSI imperfections, when the number of transmit antenna increases.

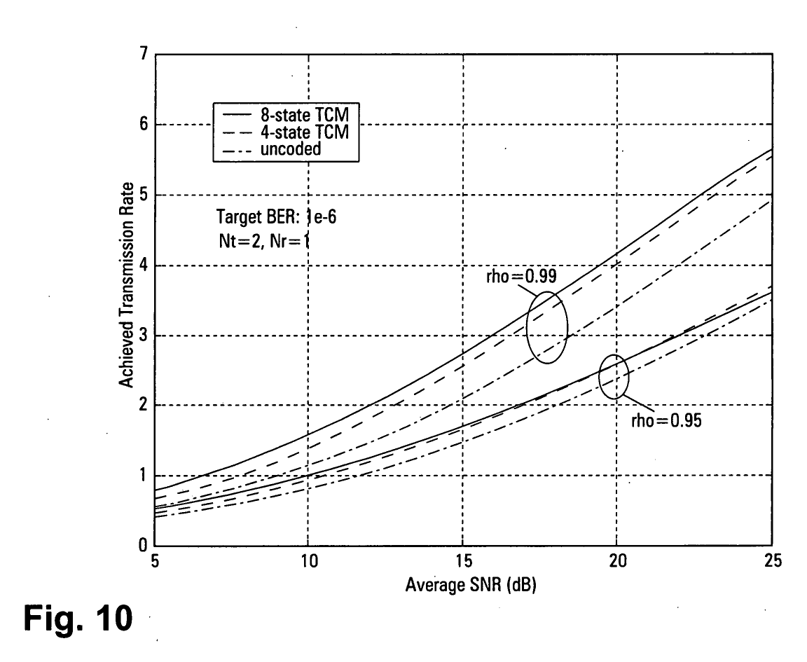

FIG. 10 is a plot that illustrates the achieved rate improvement with trellis coded modulation. In this example, the four-state and eight-state trellis codes described above were tested. First P_{b,target} was set to 10⁻⁶, Nₜ=2; Nᵣ=1. When the feedback quality is near perfect (p=0.99), the rate is considerably increased by using trellis coded modulation instead of uncoded modulation, in agreement with the prefect CSI case. However, the achieved SNR gain decreases quickly as the feedback quality drops, as shown in FIG. 10. This can be predicted, since increasing the Euclidean distance by TCM with set partitioning is less effective for fading channels (ρ<1) than for AWGN channels (ρ=1). If affordable, coded bits can be interleaved to benefit from time diversity, as suggested. This is suitable for the 8-state TCM, where the subset sequences dominate the error performance.

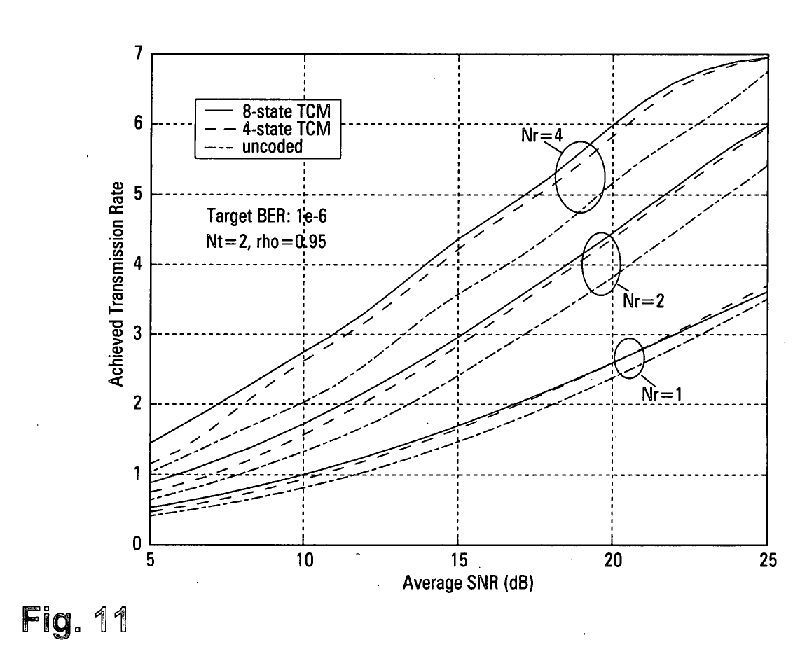

On the other hand, the Euclidena distance becomes the appropriate performance measure, when the number of receive antennas increases, as established. The SNR gain introduced by TCM is thus restored, as shown in FIG. 11 with Nᵣ=2, 4.

Comparing FIG. 10 with FIG. 7, one can observe that the adaptive system is more sensitive to noisy feedback when the prescribed bit error rate is small (10⁻⁶) as opposed to large (10⁻³).

In accordance with these techniques, adaptive modulation for multi-antenna transmissions with channel mean feedback can be achieved. Based on a two dimensional beamformer, the proposed transmitter optimally adapts the basis beams, the power allocation between two beams, and the signal constellation, to maximize the transmission rate while guaranteeing a target BER. Both uncoded and trellis coded modulation have been addressed. Numerical results demonstrated the rate improvement enabled by adaptive multi-antenna modulation, and pointed out an interesting tradeoff between feedback quality and hardware complexity. The proposed adaptive modulation maintains low receiver complexity thanks to the Alamouti structure.

Adaptive Orthogonal Frequency Division (OFDM) Multiplexed Transmissions

The techniques described above for adaptive modulation over MIMO flat-fading channels are hereinafter extended to adaptive MIMO-OFDM transmissions over frequency-selective fading channels based on partial CSI. As further described below, an OFDM transmitter applies the adaptive two-dimensional space-time coder-beamformer on each OFDM subcarrier, with the power and bits adaptively loaded across subcarriers, to maximize transmission rate under performance and power constraints.

This problem is challenging because information bits and power should be optimally allocated over space and frequency, but its solution is equally rewarding because high-performance high-rate transmissions can be enabled over MIMO frequency-selective channels. As further described, the techniques include:
Quantification of partial CSI for frequency selective MIMO channels, and formulation of a constrained optimization problem with the goal of maximizing rate for a given power budget, and a prescribed BER performance.
Design of an optimal MIMO-OFDM transmitter as a concatenation of an adaptive modulator, and an adaptive two-dimensional coder-beamformer.
Identification of a suitable threshold metric that encapsulates the allowable power and bit combinations, and enables joint optimization of the adaptive modulator-beamformer.
Incorporation of algorithms for joint power and bit loading across MIMO-OFDM subcarriers, based on partial CSI.
Illustration of the tradeoffs emerging among rate, complexity, and the reliability of partial CSI, using simulated examples.

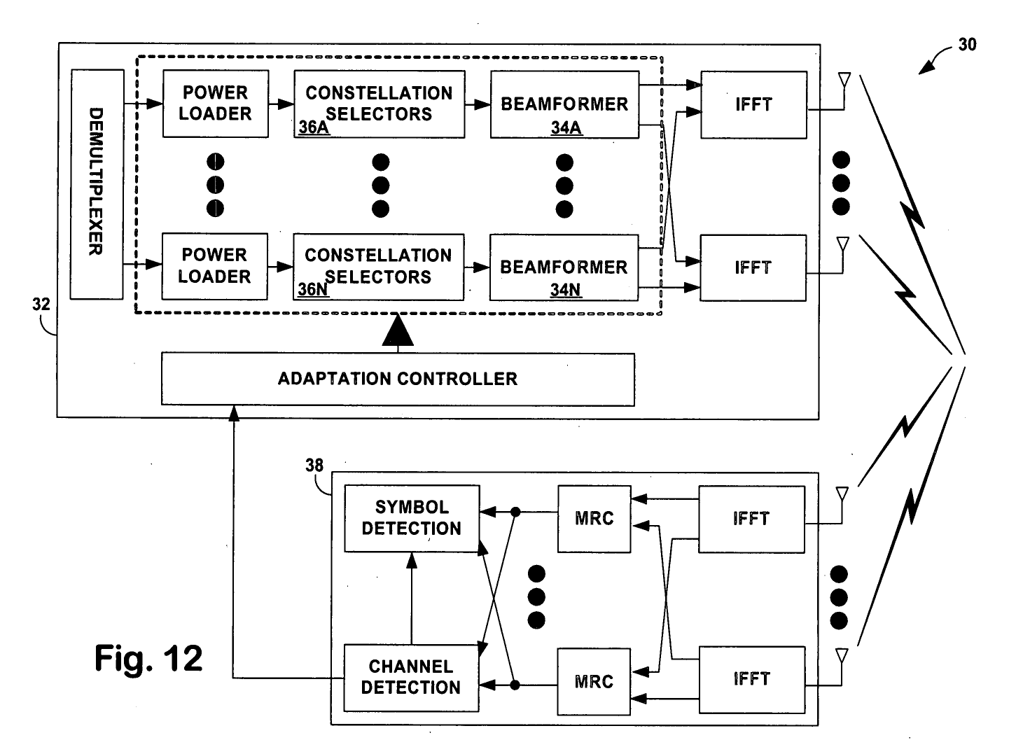

FIG. 12 is a block diagram of a wireless communication system 30 in which an adaptive MIMO-OFDM transmitter 32 applies adaptive two-dimensional coder-beamformers 34A-34N across each OFDM subcarrier, along with an adaptive power and bit loading scheme. In particular, FIG. 12 depicts an equivalent discrete-time baseband model of an OFDM wireless communication system 30 equipped with K subcarriers, Nₜ transmit-, and Nᵣ receive-antennas, signaling over a MIMO frequency selective fading channel. Per OFDM sub-carrier, transmitter 32 deploys one of adaptive two-dimensional (2D) coder-beamformers 34A-34N. Each of 2D coder-beamers 34 combines Alamouti's space time block coding (STBS) with transmit beamforming. Higher-dimensional coder-beamformers based on orthogonal STBS with Nₜ>2, can be also applied, as detailed below. However, the 2D coder-beamformers 34 strike desirable performance-rate-complexity tradeoffs, and for this reason, the 2D case is illustrated for exemplary purposes.

To apply the 2D coder-beamformer per subcarrier, two consecutive OFDM symbols are paired to form on space-time coded OFDM block. Due to frequency selectivity, different subcarriers experience generally different channel attenuation. Hence, in addition to adapting the 2D coder-beamformer on each subcarrier, the total transmit-power may also be judiciously allocated to different subcarriers based on the available CSI at transmitter 32.

Let n be used to index space time coded OFDM blocks (pairs of OFDM symbols), and let k denote the subcarrier index; i.e., k ε{0,1, . . . , K−1}. Let P[n;k] stand for the power allocated to the kth subcarrier of the nth block. Then, depending on P[n;k], a constellation (alphabet) A[n;k] consisting of M[n;k] constellation points is selected. In addition to square QAMs with M[n;k]=2²ⁱ, that have been used extensively in adaptive modulation, rectangular QAMs with M[n;k]=2²ⁱ⁺¹ are also considered. Similar to the previous analysis, the subsequent analysis focuses on rectangular QAMs that can be implemented with two independent PAMs: one for the In-phase branch with size \sqrt{2M[n;k]} and the other for the Quadrature-phase branch with size \sqrt{M[n:k]/2} as those studied. Due to the independence between I-Q branches, this type of rectangular QAM incurs modulation and demodulation complexity similar to square QAM.

For each block time-slot n, the input to each of 2D coder-beamformer 34 used per subcarrier entails two information symbols, s₁[n;k] and s₂[n;k], drawn from ^{A[n;k]}, with each one conveying
b[n;k]=log₂(M[n;k]) (44)
bits of information. These two information symbols will be space-time coded, power-loaded, and multiplexed by the 2D beamformer to generate an Nₜ×2 space-time (ST) matrix as:

$$\begin{matrix}X [ n ; k ] = {\underbrace{[ {u}_{1}^{*} [ n ; k ] , {u}_{2}^{*} [ n ; k ] ]}}_{:= {U}^{*} [ n ; k ]} \cdot [ \begin{matrix}\sqrt{{δ}_{1} [ n ; k ]} & 0 \\ 0 & \sqrt{{δ}_{2} [ n ; k ]}\end{matrix} ] \cdot \\ [ \begin{matrix}{s}_{1} [ n ; k ] & - {s}_{2}^{*} [ n ; k ] \\ {s}_{2} [ n ; k ] & {s}_{1}^{*} [ n ; k ]\end{matrix} ] ,\end{matrix} \qquad ( 45 )$$

where S[n;k] is the well-known Alamouti ST code matrix; U[n;k] is the multiplexing matrix formed by two Nₜ×1 basis-beam vectors u₁[n;k] and u₂[n;k]; and D[n;k] is the corresponding power allocation matrix on these two basis-beams with 0<δ₁[n;k],δ₂[n;k]≦1, and δ₁[n;k]+δ₂[n;k]=1. In the two time slots corresponding to the two OFDM symbols involved in the nth ST coded block, the two columns of X[n;k] are transmitted on the kth subcarrier over Nₜ transmit-antennas.

For purposes of illustration, it is assumed that the MIMO channel is invariant during each space-time coded block, but is allowed to vary form block to block. Let h_{μ,v}[n]:=[h_{μ,v}[n;0], . . . , h_{μ,v}[n;L]]^{T} be the baseband equivalent FIR channel between the μth transmit- and the vth receive-antenna during the nth block, where 1≦μ≦Nₜ, 1≦v≦Nᵣ, and L is the maximum channel order of all NₜNᵣ channels. With fₖ:=[1,e^{j2πk/N}, . . . , e^{j2πkL/N}]^{T} the frequency response of h_{μv}[n] on the kth subcarrier is:

$${H}_{μ , v} [ n ; k ] = {\sum }_{l = 0}^{L} {h}_{μ v} [ n ; l ] {ⅇ}^{- j 2 π k l / N} = {f}_{k}^{H} {h}_{μ v} [ n ] \qquad ( 46 )$$

Let H[n;k] be the Nₜ×Nᵣ matrix having H_{μv}[n;k] as its (μ, v)th entry. To isolate the transmitter design from channel estimation issues at the receiver, we suppose that the receiver has perfect knowledge of the channel H[n;k], ∀n,k.

With Y[n;k] denoting the nth received block on the kth subcarrier, we can express the input-output relationship per subcarrier and ST coded OFDM block as

$$\begin{matrix}Y [ n ; k ] = {H}^{T} [ n ; k ] X [ n ; k ] + W [ n ; k ] \\ = {H}^{T} [ n ; k ] U * [ n ; k ] D [ n ; k ] S [ n ; k ] + W [ n ; k ]\end{matrix} \qquad ( 47 )$$

where W[n;k] stands for the additive white Gaussian noise (AWGN) at the receiver with each entry having variance N₀/2 per real and imaginary dimension. Based on (47), one can view our coded-beamformed MIMO OFDM transmissions per subcarrier as an Alamouti transmission with ST matrix S[n;k] passing through an equivalent channel matrix B^{T}[n;k]:=H^{T}[n;k] U*[n;k] D[n;k]. With knowledge of this equivalent channel and maximum ratio combining (MRC) at receiver 38, it can be verified that each information symbol is thus passing through an equivalent scalar channel with I/O relationship
zᵢ[n;k]=h_{eqv}[n;k]sᵢ[n;k]+wᵢ[n;k],i=1,2, (48)
where the equivalent channel is:
h_{eqv}[n;k]=∥B[n;k]∥_{F}=[δ₁[n;k]∥H^{H}[n;k]u₁[n;k]∥_{F}²+δ₂[n;k]∥H^{H}[n;k]u₂[n;k]∥_{F}²]^{1/2}. (49)
Partial CSI for Frequency-Selective MIMO Channels

Mean feedback has been described above in reference to flat-fading multi-antenna channels to account for channel uncertainty at the transmitter, where the fading channels are modeled as Gaussian random variables with non-zero mean and white covariance. This mean feedback model is adopted for each OFDM subcarrier of the OFDM system 30 of FIG. 12. Specifically, it is assumed that on each subcarrier k, transmitter 32 obtains an un-biased channel estimate \overline{H}[n;k] either through a feedback channel, or during a duplex mode operation, or, by predicting the channel from past blocks. Transmitter 32 treats this “nominal channel” \overline{H}[n;k] as deterministic, and in order to account for CSI uncertainty, it adds a “perturbation” term. The partial CSI of the true Nₜ×Nᵣ MIMO channel H[n;k] at transmitter 32 is thus perceived as:
\check{H}[n;k]=\overline{H}[n;k]+Ξ[n;k],k=0,1, . . . , K−1, (50)
where Ξ[n;k] is a random matrix Gaussian distributed according to CN(0_{N}_{ₜ}_{×N}_{_{r,}}Nᵣσ_{ε}²[n;k]I_{N}_{ₜ}). The variance σ_{ε}²[n;k] encapsulates the CSI reliability on the kth subcarrier.

Suppose that the FIR channel taps have been acquired perfectly at the receiver, and are fed back to the transmitter with a certain delay, but without errors thanks to powerful error control codes used in the feedback. Let us also assume that the following conditions hold true:
i) The L+I taps

$${\{ {h}_{μ v} [ n ; l ] \}}_{l = 0}^{L} in {h}_{μ v} [ n ]$$
are uncorrelated, but not necessarily identically distributed (to account for e.g., exponentially decaying power profiles). Each tap is zero-mean Gaussian with variance σ_{μv}²[l] Hence,
   h_{μv}[n]˜CN(0,Σ_{μv}), where Σ_{μv}:=diag(σ_{μv}²[0], . . . ,σ_{μv}²[l]).
ii) The FIR channels

$${\{ {h}_{μ v} [ n ] \}}_{μ = 1 , v = 1}^{{N}_{t} , {N}_{r}}$$
between different transmit- and receive-antenna pairs are independent. This requires antennas to be spaced sufficiently far apart from each other.
iii) All FIR channels have the same total energy on the average σₕ²=tr{Σ_{μv}}, ∀μ,v. This is reasonable in practice, since the multi-antenna transmissions experience the same scattering environment.
iv) All channel taps are time varying according to Jakes' model with Doppler frequency f_{d}.

At the nth block, assume the channel feedback

$${\{ {h}_{μ v}^{f} [ n ] \}}_{μ = 1 , v = 1}^{{N}_{t} , {N}_{r}} ,$$

that corresponds to the true channels N_{b} blocks earlier is obtained; i.e. h_{μv}^{f}[n]=h_{μv}[n−N_{b}]. Assume each space time coded block has time duration T_{b} seconds. Then, h_{μv}^{f}[n] is drawn from the same Gaussian distribution as h_{μv}[n], but N_{b}T_{b} seconds ahead. Let ρ:=J₀(2πf_{d}N_{b}T_{b}) denote the correlation coefficient specified by Jakes' model, where J₀(•) is the zeroth order Bessel function of the first kind. The MMSE predictor of h_{μv}[n], and i), is \overline{h}_{μv}[n]=ρₕj_{μv}^{f}[n] To account for the prediction imperfections, the transmitter forms an estimate h_{μv}[n] as:
\check{h}_{μv}[n]=\overline{h}_{μv}[n]+ξ_{μv}[n], (51)
where ξ_{μv}[n] is the prediction error. Under i), it can be verified that
ξ_{μv}[n]˜CN(0,(1−|ρ|²)Σ_{μv}). (52)

The mean feedback model on channel taps described above can be translated to the CSI on the channel frequency response per subcarrier. Based on this, the matrices with (μv)th entries can be obtained: [\check{H}[n;k]]_{μv}=fₖ^{H}\check{h}_{μv}[n],[\overline{H}[n;k]]_{μv}=fₖ^{H}\overline{h}_{ηv}, and [Ξ[n;k]]_{μv}=fₖ^{H}ξ_{μv}[n]. Using i), ii), and (52), it can be verified that Ξ[n;k] has covariance matrix Nᵣ(1−|ρ|²)σₕ²I_{N}_{ₜ}. Notice that in this case, the uncertainty indicators σ_{ε}²[n;k]=(1−|ρ|²)σₕ² are common to all subcarriers.

Notwithstanding, the partial CSI has also unifying value. When K=1, it boils down to the partial CSI for flat fading channels. With σ_{ε}²=0, it reduces to the perfect CSI of the MIMO setup considered. When Nₜ=Nᵣ=1, it simplifies to the partial CSI feedback used for SISO FIR channels. Furthermore, with Nₜ=Nᵣ=1 and σ_{ε}²=0 it is analogous to perfect CSI feedback for wireline DMT channels.

One objective is to optimize the MIMO-OFDM transmissions in FIG. 12, based on partial CSI available at the transmitter. Specifically, we may want to maximize the transmission rate subject to a power constraint, while maintaining a target BER performance on each subcarrier. Let \overline{BER}[n; k] denote the perceived average BER at the transmitter on the kth subcarrier of the nth block, and \overline{BER}₀[k] stand for the prescribed target BER on the kth subcarrier. The target BERs can be identical, or, different across subcarriers, depending on system specifications. Recall that each space-time coded block conveys two symbols, S₁[n;k],s₂[n;k], and thus 2b[n;k] bits of information on the kth subcarrier. One goal is thus formulated as the following constrained optimization problem:

$$maximize 2 {\sum }_{k = 0}^{K - 1} b [ n ; k ] \\ subject to \\ \begin{matrix}c1 & \overline{BER} [ n ; k ] = & {\overline{BER}}_{0} [ k ] , ∀ k \\ c2 & {\sum }_{k = 0}^{K - 1} P [ n ; k ] = {P}_{total} and & P [ n ; k ] \geq 0 , ∀ k \\ c3 & b [ n ; k ] ɛ \{ 0 , 1 , 2 , 3 , 4 , 5 , 6 , … \} , & \end{matrix} \qquad ( 53 )$$

where Pₜₒₜₐₗ is the total power available to the transmitter per block.

The constrained optimization in (10) calls for joint adaptation of the following parameter:
power and bit loadings

$${\{ P [ n ; k ] , b [ n ; k ] \}}_{k = 0}^{K - 1}$$
across sub-carriers;
basis-beams per subcarrier

$${\{ {u}_{1} [ n ; k ] , {u}_{2} [ n ; k ] \}}_{k = 0}^{K - 1}$$
power splitting between the two basis-beams per subcarrier

$$\{ {δ}_{1} [ n ; k ] , {{δ}_{2} [ n ; k ]}_{k = 0}^{K - 1} .$$

Compared with the constant-power transmissions over flat-fading MIMO channels, the problem here is more challenging, due to the needed power loading across OFDM subcarriers, which in turn depends on the 2D beamformer optimization per subcarrier. Intuitively speaking, our problem amounts to loading power and bits optimally across space and frequency, based on partial CSI.

Adaptive MIMO-OFDM With 2D Beamforming

For notational brevity, we drop the block index n, since our transmitter optimization is going to be performed on a per block basis. Our transmitter includes an inner stage (adaptive beamforming) and an outer stage (adaptive modulation). Instrumental to both stages is a threshold metric, d₀²[k], which determines allowable combinations of (P[k],b[k]), so that the prescribed \overline{BER}₀[k] is guaranteed.

Next, the basis beams u₁[k],u₂ [k], and the corresponding percentages δ₁[k],δ₂ [k] of the power P[k] are determined for a fixed (but allowable) combination of (P[k], b[k]). Let Ts be the OFDM symbol duration with the cyclic prefix removed, and without loss of generality, let us set Ts=1. With this normalization, the constellation chosen for the kth subcarrier has average energy εₛ[k]=P[k]Tₛ=P[k], and contains M[k]=2^{b[k]} signaling points. If dₘᵢₙ²[k] denotes the minimum square Euclidean distance for this constellation, we will find it convenient to work with the scaled distance metric

$${d}^{2} [ k ] := {d}_{min}^{2} [ k ] / 4 ,$$

because for QAM constellations, it holds that,

$${d}_{min}^{2} [ k ] = 4 {d}^{2} [ k ] = 4 g ( b [ k ] ) {ɛ}_{s} [ k ] = 4 g ( b [ k ] ) P [ k ] , \qquad ( 54 )$$

where the constant g(b) depends on whether the chosen constellation is rectangular, or, square QAM:

$$g ( b ) := \{ \begin{matrix}\frac{6}{5 \cdot {2}^{b} - 4} , & b = 1 , 3 , 5 , … \\ \frac{6}{4 \cdot {2}^{b} - 4} , & b = 2 , 4 , 6 , …\end{matrix} \qquad ( 55 )$$

Notice, that d²[k] summarizes the power and constellation (bit) loading information that the adaptive modulator passes on to the coder-beamformer. The later relies on d²[k] and the partial CSI to adapt its design so as to meet constraint C1. To proceed with the adaptive beamformer design, we therefore need to analyze the BER performance of the scalar equivalent channel per subcarrier, with input sᵢ[k] and output zᵢ[k], as described by (48). For each (deterministic) realization of h_{eqv}[k], the BER when detecting sᵢ[k] in the presence of AWGN in (5), can be approximated as
BER[k]≈0.2 exp(−h_{eqv}²[k]d²[k]/N₀) (56)
where the validity of the approximation has also been confirmed. Based on our partial CSI model, the transmitter perceives h_{eqv}[k]as a random variable, and evaluates the average BER performance on the kth subcarrier as:
\overline{BER}[k]≈0.2E[exp(−h_{eqv}²[k]d²[k]/N₀)] (57)

We will adapt our basis beams u₁[k], u₂[k] to minimize \overline{BER}[k] for a given d²[k], based on partial CSI. To this end, we consider the eigen decomposition on the “nominal channel” per subcarrier (here the kth)
\overline{H}[k]\overline{H}^{H}[k]=\overline{U}_{H}[k]Λ_{H}^{H}[k], with
\overline{U}_{H}[k]:=[\overline{u}_{H,1}[k], . . . ,\overline{u}_{H,N}_{ₜ}[k]],
Λ_{H}[k]:=diag(λ₁[k], . . . , λ_{N}_{ₜ}[k]), (58)
where \overline{u}_{H}[k] is unitary, and Λ_{H}[k] contains on its diagonal the eigenvalues in a non-increasing order: λ₁[k]≧ . . . ≧λ_{N}_{_{T}}[k]≧0. As proved, the optimal u₁[k] and u₂[k] minimizing the \overline{BER}[k] are:
u₁[k]=\overline{u}_{H,1}[k],u₂[k]=\overline{u}_{H,2}[k] (59)
Notice that the columns of \overline{U}_{H}[k] are also the eigenvectors of the channel correlation matrix E{\check{H}[k]\check{H}^{H}[k]}=\overline{H}[k]\overline{H}^{H}[k]+Nᵣσ_{ε}²[k]I_{N}_{ₜ}, that is perceived by the transmitter based on partial CSI. Hence, the basis beams u₁[k] and u₂[k] adapt to the two eigenvectors of the perceived channel correlation matrix, corresponding to the two largest eigenvalues.

Having obtained the optimal basis beams, to complete our beamformer design, we have to decide how to split the power P[k] between these two basis beams.

With the optimal basis beams, the equivalent scalar channel is:
h_{eqv}²=δ₁∥\check{H}^{H}[k]\overline{u}_{H,1}[k]∥²+δ₂[k]∥\check{H}^{H}[k]\overline{u}_{H,2}[k]∥². (60)

For i=1,2, the vector \check{H}^{H}[k]\overline{u}_{H,i}[k]in (17) is Gaussian distributed with CN(\overline{H}^{H}[k]\overline{u}_{H,i}[k],σ_{ε}²[k]I_{N}_{ᵣ}). Furthermore, we have that ∥\overline{H}^{H}[k]\overline{u}_{H,i}[k]∥²=λᵢ[k]. For an arbitrary vector a˜CN(μ, Σ), the following identity holds true.
E{exp(−a^{H}a)}=exp(−μ^{H}(I+Σ)⁻¹μ)/det(I+Σ). (61)

Substituting (60) into (57), and applying (61), we obtain:

$$\begin{matrix}\overline{BER} [ k ] \approx 0.2 {\prod }_{μ = 1}^{2} [ {( \frac{1}{1 + {δ}_{μ} [ k ] {d}^{2} [ k ] {σ}_{ɛ}^{2} [ k ] / {N}_{0}} )}^{Nr} \cdot ] \\ exp ( - \frac{{λ}_{μ} [ k ] {δ}_{μ} [ k ] {d}^{2} [ k ] / {N}_{0}}{1 + {δ}_{μ} [ k ] {d}^{2} [ k ] {σ}_{ɛ}^{2} [ k ] / {N}_{0}} )\end{matrix} \qquad ( 62 )$$

Eq. (62) shows that the power splitting percentages δ₁[k],δ₂[k], depend on λ₁[k],λ₂[k], and d²[k]. Their optimum values can be found by minimizing (62) to obtain:
δ₁[k]=min(\overline{δ}₁[k],1), δ₂[k]=max(\overline{δ}₂[k],0), (63)
where, with K_{μ}[k]:=λ_{μ}[k]/(Nᵣσ_{ε}²[k]) and m_{μ}[k]:=(1+K_{μ}[k])²/(1+2K_{μ}[k]),μ=1,2, we have

$$\begin{matrix}{\overline{δ}}_{μ} [ k ] = \frac{{m}_{μ} [ k ]}{{\sum }_{i} {m}_{i} [ k ]} + \frac{{m}_{u} [ k ]}{{d}^{2} [ k ] {σ}_{ɛ}^{2} [ k ] / {N}_{0}} \times \\ ( \frac{{\sum }_{i} \frac{{m}_{i} [ k ]}{1 + {K}_{i} [ k ]}}{{\sum }_{i} {m}_{i} [ k ]} - \frac{1}{1 + {K}_{μ} [ k ]} ) , μ = 1 , 2.\end{matrix} \qquad ( 64 )$$

The solution guarantees that 0≦δ₂[k]≦δ₁[k]≦1, and δ₁[k]+δ₂[k]=1. Based on the partial CSI (\overline{H}[k],σ_{ε}²[k]), eqns. (16) and (20) provide the 2D coder-beamformer design with the minimum \overline{BER}[k], that is adapted to a given d²[k] output of the adaptive modulator. Because this minimum \overline{BER}[k] depends on d²[k], the natural question at this point is: for which values of d²[k], call it d₀²[k], will the minimum \overline{BER}[k] reach the target \overline{BER}₀[k]?

We next establish that \overline{BER}[k] in (62), with {δᵢ{k}}ᵢ₌₁² specified in (63), is a monotonically decreasing function of d²[k].

Lemma: Given partial CSI, the \overline{BER}[k] in (62) is a monotonically decreasing function of d²[k]. Hence, there exists a threshold d₀²[k]for which \overline{BER}[k]≦\overline{BER}₀[k] if and only if d²[k]≧d₀² [k]. The threshold d₀²[k] is found by solving (19) with respect to d²[k], when \overline{BER}[k]≦\overline{BER}₀[k].

Proof: A detailed proof requires the derivative of \overline{BER}[k] with respect to d²[k], over two possible scenarios: δ₂[k]=0, and δ₂[k]>0, as indicated by (63). We have verified that this derivative is always less than zero for any given d²[k]. However, we will skip the lengthy derivation, and provide an intuitive justification instead. Suppose that δ₁[k] and δ₂[k] are optimized as in (20) for a given d²[k]. Now, let us increase d²[k] by an amount Δ_{d}. Even when δ₁[k] and δ₂[k] are fixed to previously optimized values (i.e, even if the 2D coder-beamformer is non-adaptive) the corresponding BER decreases, since signaling with larger minimum distance always leads to better performance. With the minimum constellation distance d²[k]+Δ_{d}, optimizing δ₁[k] and δ₂[k]will further decrease the BER. Hence, increasing d²[k] decreases \overline{BER}[k] monotonically.

This lemma implies that we can obtain the desirable d²[k]. However, since no closed-form solution appears possible, we have to rely on a one-dimensional numerical search.

To avoid the numerical search, we next propose a simple, albeit approximate, solution for d₀² [k]. Notice that eq. (62) is nothing but the average BER of an 2Nᵣ-branch diversity combining system, with Nᵣ branches undergoing Rician fading with Rician factor K₁[k]=λ₁[k]/(Nᵣσ_{ε}²[k]); while the other Nᵣ branches are experiencing Rician fading with Rician factor K₂[k]=λ₂[k]/(Nᵣσ_{ε}²[k]). Approximating a Rician distribution by a Nakagami-m distribution, we can approximate the \overline{BER}[k] by:

$${\overline{BER}}^{′} [ k ] \approx \frac{1}{5} {∐}_{μ = 1}^{2} {( 1 + {δ}_{μ} [ k ] \frac{( 1 + {K}_{μ} [ k ] {d}^{2} [ k ] {σ}_{ɛ}^{2} [ k ] )}{{m}_{μ} [ k ] \cdot {N}_{0}} )}^{- {m}_{μ} [ k ] {N}_{r}} , \qquad ( 65 )$$

where m_{μ} is defined after eq. (63). It can be easily verified that \overline{BER}′[k] is also monotonically decreasing as d²[k] increases. Setting \overline{BER}′[k]=\overline{BER}₀[k], we can solve for d₀² [k] using the following two-step approach:

Step 1: Suppose that d₀²[k] can be found with δ₂[k]>0. Substituting (64) into (65), we obtain:

$$\begin{matrix}{d}_{0}^{2} [ k ] = [ \frac{{A}_{0} [ k ] \cdot {( 5 {\overline{BER}}_{0} [ k ] )}^{- 1 / ( {A}_{0} ( k ] {N}_{r} )}}{{\prod }_{μ = 1}^{2} {( 1 + {K}_{μ} [ k ] )}^{{m}_{μ} [ k ] / {A}_{0} [ k ]}} - {B}_{0} [ k ] ] \cdot \frac{{N}_{0}}{{σ}_{ɛ}^{2} [ k ]} , & ( 66 ) \\ where & \\ \begin{matrix}{A}_{0} [ k ] := {\sum }_{i = 1}^{2} {m}_{i} [ k ] , & {B}_{0} [ k ] := {\sum }_{i = 1}^{2} \frac{{m}_{i} [ k ]}{1 + {K}_{i} [ k ]} ,\end{matrix} & ( 67 )\end{matrix}$$

To verify the validity of the solution, let us substitute d₀²[k]into (21). If \overline{δ}₂[k]>0 is satisfied, then (66) yields the desired solution. Otherwise, we go to step 2.

Step 2: When Step 1 fails to find the desired d₀²[k] with δ₂[k]>0, we set δ₂[k]=0 Substituting δ₁[k]=1 and δ₂[k]=0, we have

$${d}_{0}^{2} [ k ] = \frac{{( 5 {\overline{BER}}_{0} [ k ] )}^{- 1 / ( {m}_{1} [ k ] {N}_{r} )} - 1}{( 1 + {K}_{1} [ k ] ) / {m}_{1} [ k ]} \cdot \frac{{N}_{0}}{{σ}_{ε}^{2} [ k ]} , \qquad ( 68 )$$

This approximate solution of d₀²[k] avoids numerical search, thus reducing the transmitter complexity.

We next detail some important special cases.

Special Case 1—MIMO OFDM with one-dimensional (1D) beamforming based on partial CSI: The 1D beamforming is subsumed by the 2D beamforming if one fixes a priori the power percentages to δ₁[k]=1, and δ₂[k]=0. In this case, d₀²[k] can be found in closed-form.

Special Case 2—SISO-OFDM based on partial CSI: The single-antenna OFDM based on partial CSI can be obtained by setting Nₜ=Nᵣ=1. In this case, λ₁[k]=|\overline{H}[k]|², where \overline{H}[k] is the “nominal channel” on the kth subcarrier. Hence, this yields d₀²[k] in this case too, after setting Nᵣ=1, and K₁:=∥\overline{H}[k]∥²/σ_{ε}²[k].

Special Case 3—MIMO-OFDM based on perfect CSI: With σ_{φ}²[k=0] the adaptive beamformer on each OFDM subcarrier reduces the ID beamformer with δ₂[k]=0. This corresponds to the MIMO-OFDM system, when cochannel interference (CCI) is absent. In this special case, no Nakagami approximation is need, and the BER performance simplifies to
\overline{BER}[k]=0.2exp(−d²[k]λ₁[k]/N₀), (69)
which leads to a simpler calculation of the threshold metrics as
d₀²[k]=[tn(5\overline{BER}₀[k])]N₀/λ₁[k] (70)

Special Case 4—Wireline DMT systems: The conventional wireline channel in DMT systems, can be incorporated in our partial CSI model by setting Nₜ=1, Nᵣ=1, and σ_{ε}²[k]=0. In this case, the threshold metric d₀²[k] is given by (70) with λ₁[k]=|H[k] ^{2 .}

Adaptive Modulation Based on Partial CSI

With d₀²[k] encapsulating the allowable (P[k],b[k]) pairs per subcarrier, we are ready to pursue joint power and bit loading across OFDM subcarriers to maximize the data rate. It turns out that after suitable interpretations, many existing power and bit loading algorithms developed for DMT systems, can be applied to the adaptive MIMO-OFDM system based on partial CSI. We first show how the classical Hughes-Hartogs algorithm (HHA) can be utilized to obtain the optimal power and bit loadings.

1) Optimal Power and Bit Loading: As the loaded bits assume finite (non-negative integer) values, a globally optimal power and bit allocation exists. Given any allocation of bits on all subcarriers, we can construct it in a step by step bit loading manner, with each step adding a single bit on a certain subcarrier, and incurring a cost quantified by the additional power needed to maintain the target BER performance. This hints towards the idea behind the Hughes Hartogs algorithm (HHA): at each step, it tries to find which subcarrier supports one additional bit with the least required additional power. Notice that the HHA belongs to the class of greedy algorithms that have found many applications such as the minimum spanning tree, and Huffman encoding.

The minimum required power to maintain i bits in the kth sub carrier with threshold metric d₀²[k] is d₀²[k]/g(i). Therefore, the power cost incurred when loading the ith bit to the kth subcarrier is

$$\begin{matrix}c ( k , i ) = \frac{{d}_{0}^{2} [ k ]}{g ( i )} = \frac{{d}_{0}^{2} [ k ]}{g ( i - 1 )} , & i \geq 1 , ∀ k .\end{matrix} \qquad ( 71 )$$

For i=1, we set g(i−1)=∞, and thus c(k,1)=d₀²[k]/g(1). In the following algorithm, we will use Pᵣₑₘ to record the remaining power after each bit loading step, b_{c}[k] to store the number of bits already loaded on the kth subcarrier, and P_{c}[k] to denote the amount of power currently loaded on the kth subcarrier. Now we are ready to describe the greedy algorithm for joint power and bit loading of the adaptive MIMO-OFDM based on partial

The Greedy Algorithm:

1) Initialization: Set Pᵣₑₘ=Pₜₒₜₐₗ. For each subcarrier, set b_{c}[k]=P_{c}[k]=0 and compute d₀²[k].

2) Choose the subcarrier that requires the least power to load one additional bit; i.e., select

$${k}_{0} = arg {min}_{k} c ( k , {b}_{c} [ k ] + 1 ) \qquad ( 72 )$$

3) If the remaining power cannot accommodate it, i.e., if Pᵣₑₘ<c(k₀,b_{c}[k₀]+1), then exit with P[k]=P_{c}[k], and b[k]=b_{c}[k]. Otherwise, load one bit to subcarrier k₀, and update state variables as
Pᵣₑₘ=Pᵣₑₘ−c(k₀,b_{c}[k₀+1]), (73)
P_{c}[k₀]=P_{c}[k₀]+c(k₀,b_{c}[k₀]+1), (74)
b_{c}[k₀]=b_{c}[k₀]+1. (75)

4) Loop back to step 2.

The greedy algorithm yields a “1-bit optimal” solution, since it offers the optimal strategy at each step when only a single bit is considered. In general, the 1-bit optimal solution obtained by a greedy algorithm may not be overall optimal. However, for our problem at hand, we establish in Appendix I the following:

Proposition 1: The power and bit loading solution

$${\{ P [ k ] , b [ k ] \}}_{k = 0}^{K - 1}$$

that the greed algorithm converges to, in a finite number of steps, is overall optimal.

Notice that the optimal bit loading solution may not be unique. This happens when two or more subcarriers have identical d₀²[k] under their respective (and possibly different) performance requirements. However, a unique solution can be always obtained, after establishing simple rules to break possible ties that may arise.

Allowing for both rectangular and square QAM constellations, the greedy algorithm loads one bit at a time. However, only square QAMs are used in may adaptive systems. If only square QAMs are selected during the adaptive modulation stage, we can then load two bits in each step of the greedy algorithm, and thereby halve the total number of iterations. It is natural to wonder whether restricting the class to square QAMs has a major impact on performance. Fortunately, as the following proposition establishes, limiting ourselves to square QAMs only incurs marginal loss:

Proposition 2: Relative to allowing for both rectangular and square QAMs incurs up to one bit loss (on the average) per transmitted space-time coded block, that contains two OFDM symbols.

Compared to the total number of bits conveyed by two OFDM symbols, the one bit loss is negligible when using only square QAM constellations. However, reducing the number of possible constellations by 50% simplifies the practical adaptive transmitter design. These considerations advocate only square QAM constellations for adaptive MIMO-OFDM modulation (this excludes also the popular BPSK choice).

The reason behind Proposition 2 is that square QAMs are more power efficient than rectangular QAMs. With K subcarriers at our disposal, it is always possible to avoid usage of less efficient rectangular QAMs, and save the remaining power for other subcarriers to use power-efficient square QAMs. Interestingly, this is different from the adaptive modulation over flat fading channels, where the transmit power is constant and considerable loss (on bit every two symbols on average) is involved, if only square QAM constellations are adopted.

2) Practical Considerations: The complexity of the optimal greedy algorithm is on the order of O(N_{bits}K), where N_{bits} is the total number of bits loaded, and K is the number of subcarriers. And it is considerable when N_{bits} and K are large. Alternative low-complexity power and bit loading algorithms have been developed for DMT application. Notice that [4] and [19] study a dual problem: optimal allocation of power and bits to minimize the total transmission power with a target number of bits. Interestingly, the truncated water-filling solution can be modified and used in our transmitter design, while the fast algorithm can not, since it requires knowledge of the total number of bits to start with. In spite of low-complexity, the algorithm is suboptimal, and may result in a considerable rate loss due to the truncation operation.

The overall adaptation procedure for the adaptive MIMO-OFDM design based on partial CSI can be summarized as follows:
1) Basis beams per subcarrier

$${\{ {u}_{1} [ k ] , {u}_{2} [ k ] \}}_{k = 0}^{K - 1}$$
are adapted first using (59), to obtain an adaptive 2D coder beamformer for each subcarrier.
2) Power and bit loading

$${\{ b [ k ] , P [ k ] \}}_{k = 0}^{K - 1}$$
is then jointly performed across all subcarriers, using the algorithm in [15] that offers optimality at complexity lower than the greedy algorithm.
3) Finally, power splitting between the two basis beams on each subcarrier

$${\{ {δ}_{1} [ k ] , {δ}_{2} [ k ] \}}_{k = 1}^{K}$$
is decided using (63).

### EXAMPLES

We set K=64, L=5, and assume that the channel taps are i.i.d. with covariance matrix

$${\sum }_{μ v}^{} = \frac{1}{L = 1} {I}_{L = 1}$$

We allow for both rectangular and square QAM constellations in the adaptive modulations stage. Let the average transmit-SNR (signal to noise ration) across subcarriers is defined as: SNR=PₜₒₜₐₗTₛ/(KN₀). The transmission rate (the loaded number of bits) is counted every two OFDM symbols as:

$${\sum }_{k = 0}^{K - 1} 2 b [ k ] .$$

Comparison Between Exact and Approximate Solution

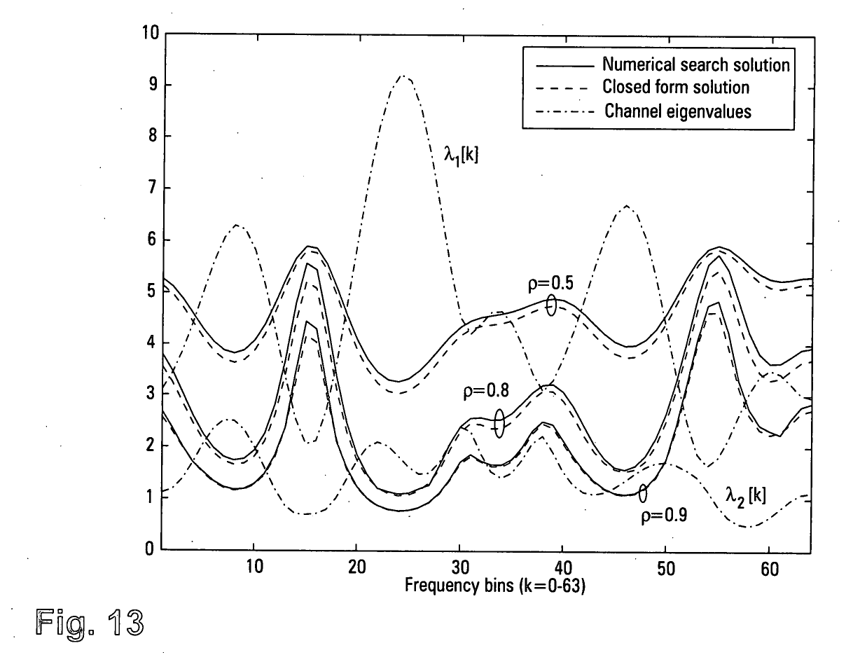

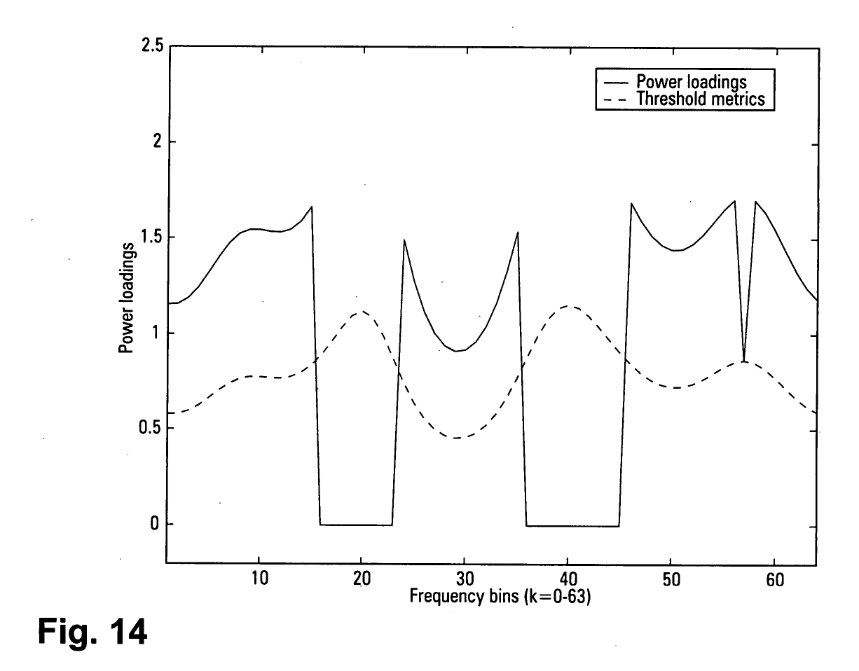

Typical MIMO multipath channels were simulated with Nₜ=4, Nᵣ=2, and N₀=1. For a certain channel realization, assuming 2D beamforming on each subcarrier, FIG. 13 plots the thresholds d₀²[k] obtained via numerical search, and from the closed-form solution based on eq. (65), with p=0.5, 0.8, 0.9 and a target BER=10⁻³. FIG. 14 is the counterpart of FIG. 13, but with target BER=10⁻⁴. The non-negative eigenvalues λ₁[k] and λ₂[k]of the nominal channels are also plotted in dash-dotted lines for illustration purpose. Observe that the solutions of d₀² [k] obtained via these two different approaches are generally very close to each other. And the discrepancy decreases as the feedback quality p increases, or, as the target \overline{BER}₀ increases. Notice that the suboptimal closed-form solution in practice, some SNR margins may be needed to ensure the target BER performance. Nevertheless, the suboptimal closed-form solution for d₀²[k] will be used in the ensuing numerical results.

FIGS. 13 and 14 also reveal that on subchannels with large eigenvalues (indicating “good quality”), the resulting d₀²[k] is small; hence, large size constellations can be afforded on those subchannels.

Power and Bit Loading with the Greedy Algorithm

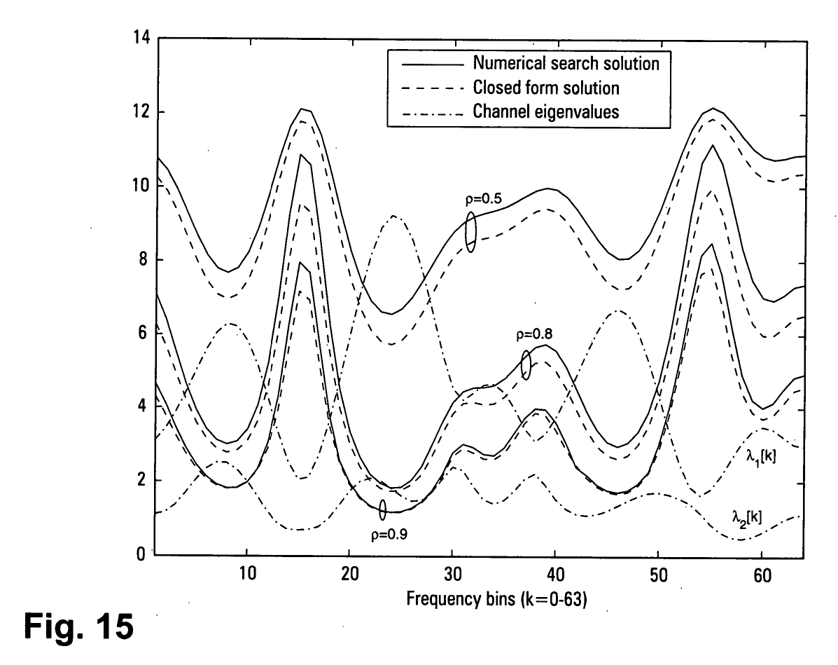

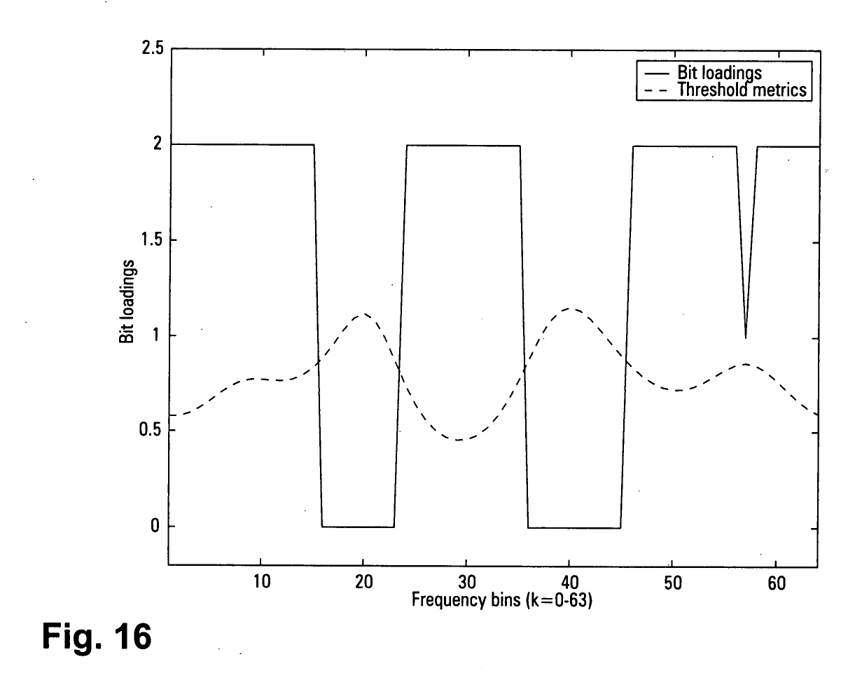

We set Nₜ=4, Nᵣ=2, ρ=0.5, SNR=9 dB, and \overline{BER}₀=10⁻⁴ For a certain channel realization, we plot the power and bit loading solutions obtained via the greedy algorithm in FIGS. 15 and 16, respectively. For illustration purpose, we also plot the threshold metrics d₀²[k]. We observe that whenever there is a change in the bit loading solution in FIG. 16 from one subcarrier to the next, there will be an abrupt change in the corresponding power loading in FIG. 15. Furthermore, for those subcarriers with the same number of bits, the power loaded by the greedy algorithm is proportional to the threshold metric. Also, from the bit loading of the greedy algorithm in FIG. 16, we see that all subcarriers are loaded with an even number of bits (with the exception of one subcarrier at most), which is consistent with Proposition 2.

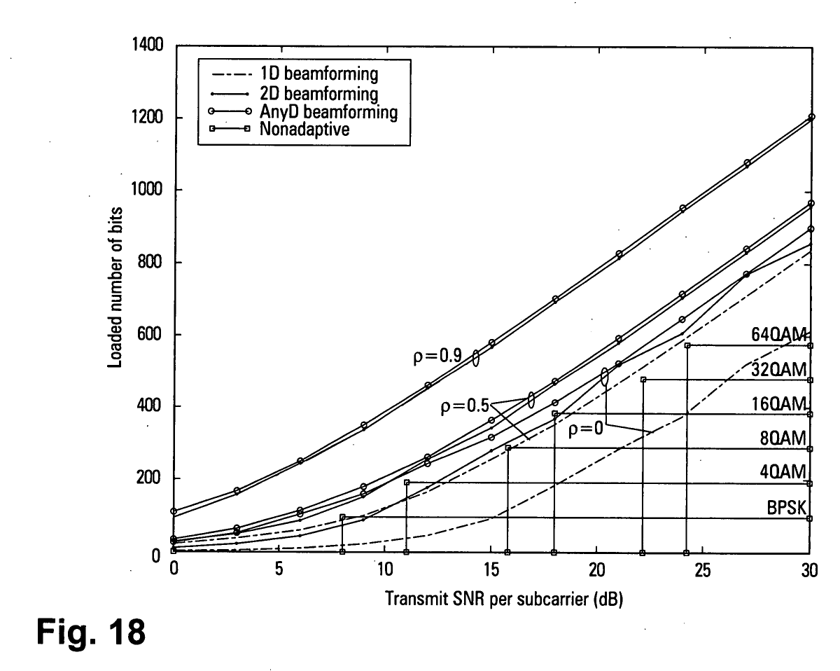

Test case 3—Adaptive MIMO OFDM based on partial CSI: In addition to the adaptive MIMO-OFDM based on 1D and 2D coder-beamformers, we derive an adaptive transmitter that relies on higher-dimensional beamformers on each OFDM subcarrier; we term it any-D beamformer here. With \overline{BER}₀=10⁻⁴, we compare non-adaptive transmission schemes (that use fixed constellations per OFDM subcarrier) and adaptive MIMO-OFDM schemes based on any-D, 2D, and 1D beamforming in FIG. 16 with Nₜ=2, Nᵣ=2, in FIG. 18 with Nₜ=4, Nᵣ=2, and in FIG. 8 with Nₜ=4, Nᵣ=4. The Alamouti codes are used when Nₜ=2, and the rate ¾ STBC code is used when Nₜ=4. The transmission rates for adaptive MIMO-OFDM are averaged over 200 feedback realizations.

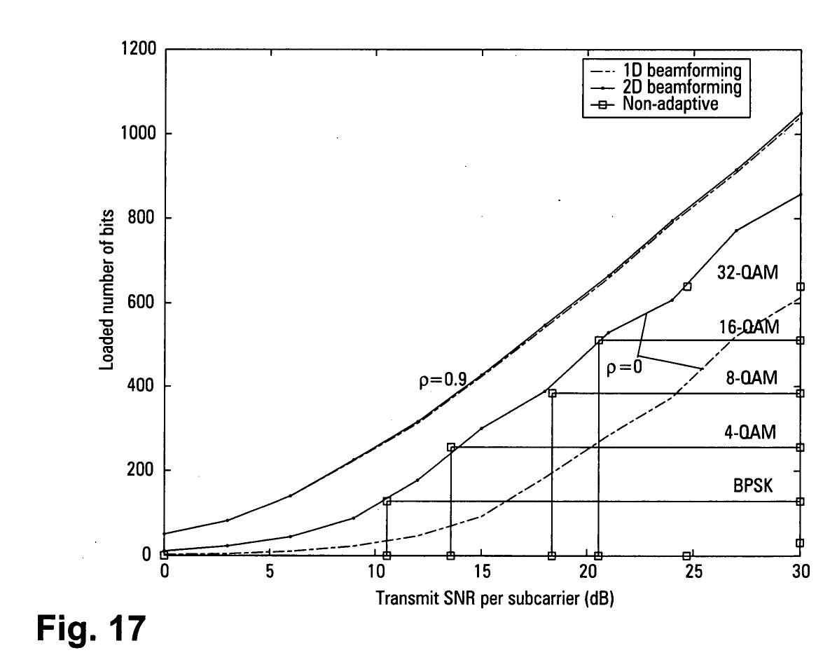

With Nₜ=2 in FIG. 17, the any-D beamformer reduces to the 2D coder-beamformer, since there are at most two basis beams. With Nₜ=4 in FIGS. 18 and 19, 23 observe that the adaptive transmitter based on 2D coder-beamformer achieves almost the same data rate as that based on any-D beamformer, for variable quality of the partial CSI (as p varies), and various size MIMO channels (as Nᵣ varies). Thanks to its reduced complexity, 2D beamforming is thus preferred over any-D beamforming. On the other hand, the 1D beamforming is considerably inferior to 2D beamforming when low quality CSI is present at the transmitter. But as CSI quality increases (e.g., ρ≧0.9), the transmitter based on ID beamforming approaches the performance of that based on 2D beamforming.

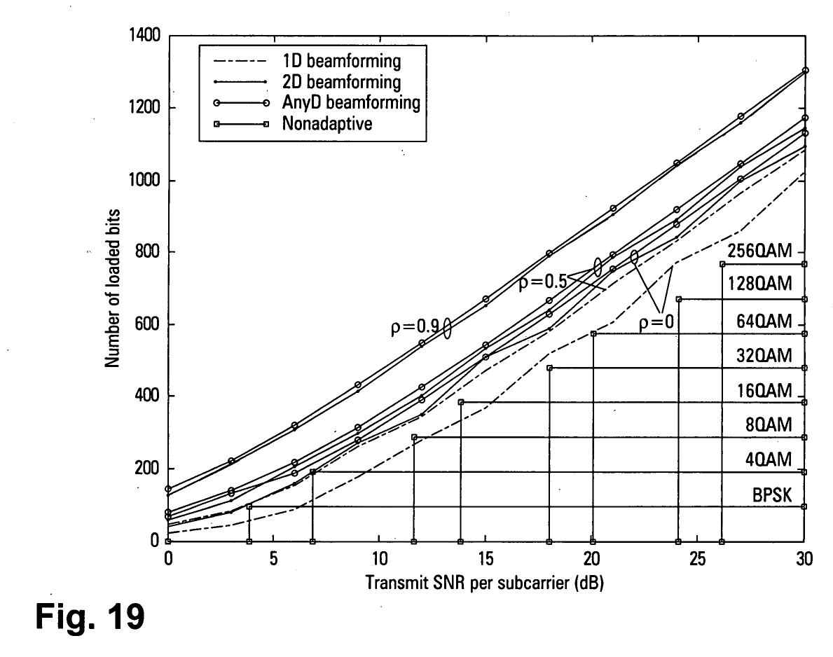

With Nₜ=2, Nᵣ=2 in FIG. 17, the adaptive MIMO-OFDM based on the 2D coder-beamformer always outperforms non-adaptive alternatives. With Nₜ=4, Nᵣ=2 in FIG. 18, the non-adaptive transmitter at the low SNR range, with extremely low feedback quality (ρ=0). However, as the SNR increases, or, the feedback quality improves, the adaptive 2D transmitter outperforms the non-adaptive transmitter considerably. As the number of receive antennas increase to Nᵣ=4 in FIG. 19, the adaptive 2D beamforming transmitter is uniformly better than the non-adaptive transmitter, regardless of the feedback quality.

Proofs

Based on (28) and (12) we have
c(k,i)=2^{2(j-1)}d₀²[k], for i=2j−1,2j, and j=1,2, . . . (76)

Table I lists the required power to load the ith bit on the kth subcarrier.

TABLE 1

| i | 1 | 2 | 3 | 4 | 5 | . . . |
|---|---|---|---|---|---|---|
| d₀²[k]/g(i) | d₀²[k] | 2d₀²[k] | 6d₀²[k] | 10d₀²[k] | 26d₀²[k] | . . . |
| c(k, i) | d₀²[k] | d₀²[k] | 4d₀²[k] | 4d₀²[k] | 16d₀²[k] | . . . |

From Table I and eq. (33), we infer that
c(k,i=1)≧c(k,i), ∀i,k. (77)

Although the greedy algorithm chooses always the 1-bit optimum, eq. (77) reveals that all future additional bits will cost no less power. This is the key to establishing the overall optimality because no matter what the optimal final solution is, the bits on each subcarrier can be constructed in a bit-by-bit fashion, with every increment being most power-efficient, as in the greedy algorithm. Hence, the greedy algorithm is overall optimal for our problem at hand. Lacking an inequality like (77), the optimality has been formally established.

An important observation from (76) is that c(k, 2j−1)=c(k, 2j) holds true for any k and j. Suppose at some intermediate step of the greedy algorithm, the (2j−1)st bit on the kth subcarrier is the chosen bit to be loaded, which means that the associated cost c(k, 2j−1) is the minimum out of all possible choices. Notice that c(k, 2j)=c(k, 2j−1) has exactly the same cost, and therefore, after loading the (2j−1)st bit on the kth subcarrier, the next bit chosen by the optimal greedy algorithm must be the (2j)th bit on the same subcarrier, unless power insufficiency is declared. So, the overall procedure effectively loads two bits at a time: as long as the power is adequate, the greedy algorithm will always load two bits in a row to each subcarrier. Let us denote the total number of bits as

$${R}_{square} = 2 {\sum }_{k = 0}^{K - 1} {b}_{1} [ n ; k ] ,$$

when using only square QAMs, and

$${R}_{rect} = 2 {\sum }_{k = 0}^{K - 1} {b}_{2} [ n ; k ]$$

when allowing also for rectangular QAMs. AT most on one subcarrier k′, it holds that b₂[n; k′]=b₁[n;k′]+1, which has probability ½; while for all other subcarriers, b₂[n;k]=b₁[n;k]+1 Hence, R_{square} is less than R_{rect} by most one bit per space time coded OFDM block.
Higher Than Two-D Beamforming

For practical deployment of the adaptive transmitter, we have advocated the 2D coder-beamformer on each OFDM subcarrier. With Nₜ>2 however, higher than 2D coder beamformers have been developed. They are formed by concatenating higher dimensional orthogonal space-time block coding designs, with properly loaded space time multiplexers. Collecting more diversity through multiple basis beams, the optimal Nₜ-dimensional beamformer outperforms the 2D coder-beamformer, from the minimum achievable \overline{BER} point of view. Hence, with more than two basis beams, the threshold metric per subcarrier may improve, and the constellation size on each subcarrier may increase under the same performance constraint. However, the main disadvantage of Nₜ-dimensional beamforming is that the orthogonal STBC design loses rate when Nₜ>2. The important issue in this context is how much one could lose in adaptive transmission rate by focusing only on the 2D coder-beamformer, instead of allowing all possible choices of beamforming that can use up to Nₜ basis beams.

In the following, we use the notation n_{tD} to denote beamforming with nₜ “strongest” basis beams. With nₜ≦2, two symbols are transmitted over two time slots as in (2). When nₜ=3,4, the beamformer can be constructed based on the rate ¾ orthogonal SBC, with three symbols transmitted over four time slots. When 5≦nₜ≦8, the beamformer can be constructed based on the rate ½ orthogonal STBC, with four symbols transmitted over eight time slots. Let us consider, for simplicity, a maximum of eight directions even when Nₜ>8, i.e., n_{t,max}=min (Nₜ, 8). If we take a super block with eight OFDM symbols as the adaptive modulation unit, then each super block allows for different nₜD beamformers on different subcarriers at each modulation adaptation step. Specifically, in one super block, one subcarrier could place four 2D coder-beamformers, or, two 4D beamformers, or one 8D beamformer, depending on partial CSI. With constellation size M[k], the corresponding transmission rate for the nₜD beamformer is 8fₙ_{ₜ} log₂ (M[k]) per subcarrier per super block, where fₙ_{ₜ}=1 for nₜ=1,2, fₙ_{ₜ}=¾ for n_{t=3,4, and f}ₙ_{ₜ}=½ for n_{t=5,6,7,8. Furthermore, with power P[k] on each subcarrier, the energy per information symbol is d}² [k]=(1/fₙ_{ₜ})g(b[k])P[k]. This includes (11) as a special case with f₁=f₂=1

As with 2D beamforming, we wish to maximize the transmission rate of the MIMO-OFDM subject to the performance constraint on each subcarrier. We first determine the distance threshold d₀²,ₙ_{ₜ}[k] on each subcarrier for the ₙ_{ₜ}D beamformer, where 1≦nₜ≦n_{t,max}. With the average BER expression for the nₜD beamformer, we find d₀²,ₙ_{ₜ}[k] through one dimensional numerical search. Hence, if the assigned constellation has d²[k]≧d₀²,ₙ_{ₜ}[k], adopting the nₜD beamformer will lead to the guaranteed BER performance, thanks to the monotonicity we established in our Lemma.

Having specified

$$\{ {d}_{0}^{2} {,}_{{n}_{i}} {[ k ]}_{k = 0}^{K - 1}$$

for each nₜ ε └1,2, . . . ,ₙ_{_{t,max}}┘, we can also modify our greedy algorithm, to obtain the optimal power and bit loading across subcarriers. First we define the effective number of bits bₑ:=bfₙ_{ₜ} when 2^{b}-QAM is used together with nₜD beamforming. Second, we constrain the effective number of bits bₑ to be integers, in order to facilitate the problem solving procedure. To achieve this, non-integer QAMs are assumed temporarily available for an nt (we will later on quantize them to the closet square or rectangular QAMs). This entails a certain approximation error, but our objective here is to quantify the difference between 2D beamforming and any nₜD beamforming. The greedy algorithm can be applied as described, but with each step loading effectively one bit on certain subcarrier. Specifically, we need to replace c(k,bₑ+1) in the original greedy algorithm with C(k,bₑ+1), where

$$c ( k , {b}_{e} + 1 ) = min [ \frac{{f}_{{n}_{i}} {d}_{o}^{2} {,}_{{n}_{i}} [ k ]}{g ( ( {b}_{e} + 1 ) / {f}_{{n}_{i}} )} ] - {min}_{{n}_{i}} [ \frac{{f}_{{n}_{i}} {d}_{o}^{2} {,}_{{n}_{i}} [ k ]}{g ( {b}_{e} / {f}_{{n}_{i}} )} ] , \qquad ( 78 )$$

is the minimal power required to load one additional bit on top of bₑ effective bits on the kth subcarrier, given that all possible nₜD beamformers can be arbitrarily chosen. Notice that the optimal beamforming, based on as many as n_{t,max} basis beams, includes 2D beamforming as a special case with n_{t,max}=2. Numerical results demonstrate that the 2D transmitter performs close to any higher dimensional one in most practical cases. However, the 2D transmitter reduces the complexity considerably, which is the reason why we favor the 2D coder-beamformer in practice.

### CONCLUSION

The described MIMO-OFDM transmissions are capable of adapting to partial (statistical) channel state information (CSI). Adaptation takes place in three (out of four) levels at the transmitter: The power and (QAM) constellation size of the information symbols; the power splitting among space-time coded information symbol substreams; and the basis-beams of two- (or generally multi-) dimensional beamformers that are used (per time slot) to steer the transmission over the flat MIMO subchannels corresponding to each subcarrier.

For a fixed transmit-power, and a prescribed bit error rate performance per subcarrier, we maximize the transmission rate for the proposed transmitter structure over frequency-selective MIMO fading channels. The power and bits are judiciously allocated across space and subcarriers (frequency), based on partial CSI. Analogous to perfect-CSI-based DMT schemes, we established that loading in our partial-CSI-based MIMO OFDM design is controlled by a minimum distance parameter (which is analogous to the SNR-threshold used in DMT systems) that depends on the prescribed performance, the channel information, and its reliability, as those partially (statistically) perceived by the transmitter. This analogy we established offers two important implications: i) it unifies existing DMT metrics under the umbrella of partial CSI; and ii) it allows application of existing DMT loading algorithms from the wireline (perfect CSI) setup to the pragmatic wireless regime, where CSI is most often known only partially.

Regardless of the number of transmit antennas, the adaptive two-dimensional coder-beamformer should be preferred in practice, over higher-dimensional alternatives, since it enables desirable performance-rate-complexity tradeoffs.

Various embodiments of the invention have been described. The described techniques can be embodied in a variety of transmitters including base stations, cell phones, laptop computers, handheld computing devices, personal digital assistants (PDA's), and the like. The devices may include a digital signal processor (DSP), field programmable gate array (FPGA), application specific integrated circuit (ASIC) or similar hardware, firmware and/or software for implementing the techniques. In other words, constellation selectors and Eigen-beam-formers, as described herein, may be implemented in such hardware, software, firmware, or the like.

If implemented in software, a computer readable medium may store computer readable instructions, i.e., program code, that can be executed by a processor or DSP to carry out one of more of the techniques described above. For example, the computer readable medium may comprise random access memory (RAM), read-only memory (ROM), non-volatile random access memory (NVRAM), electrically erasable programmable read-only memory (EEPROM), flash memory, or the like. The computer readable medium may comprise computer readable instructions that when executed in a wireless communication device, cause the wireless communication device to carry out one or more of the techniques described herein. These and other embodiments are within the scope of the following claims.

1. A wireless communication device comprising:
a constellation selector that adaptively selects a signal constellation from a set of constellations based on channel state information for a wireless communication channel, wherein the constellation selector maps information bits of an outbound data stream to symbols drawn from the selected constellation to produce a stream of symbols;
a beamformer that generates a plurality of coded data streams from the stream of symbols; and
a plurality of transmit antennas that output waveforms in accordance with the plurality of coded data streams.

2. The wireless communication device of claim 1, wherein the constellation selector selects the signal constellation based at least in part on partial information for the wireless communication channel.

3. The wireless communication device of claim 1, wherein the constellation selector selects the signal constellation based at least in part on channel mean feedback received from a second wireless communication device.

4. The wireless communication device of claim 1, wherein the constellation selector selects the signal constellation based at least in part on a target throughput.

5. The wireless communication device of claim 1, wherein the beamformer comprises a space-time block coder that processes the stream of symbols from the constellation selector to generate space-time block coded data streams.

6. The wireless communication device of claim 5, wherein the space-time block coder processes the stream of symbols to generate N space-time block coded data streams, where N equals the number of transmit antennas.

7. The wireless communication device of claim 5, wherein the beamformer comprises a power splitter that controls a total power allocated across the space-time block coded data streams.

8. The wireless communication device of claim 7, wherein the power splitter adjusts the power allocated to the space-time block coded streams based at least in part on the channel information.

9. The wireless communication device of claim 7, wherein the power splitter adaptively adjusts allocation of total power across the space-time coded data streams as a function of the constellation that is selected by the constellation selector.

10. The wireless communication device of claim 1, wherein the power splitter adjusts a power allocation of the data streams to maximize the transmission rate while maintaining a target bit error rate.

11. The wireless communication device of claim 1, wherein the beamformer applies an antenna weighting vector to the space-time coded data streams to allocate a portion of each of the space-time coded data streams to each of the output antennas.

12. The wireless communication device of claim 11, wherein the beamformer adaptively adjusts the antenna weighting vector based on the channel state information.

13. The wireless communication device of claim 12, wherein the antenna weighting vector comprises an eigen vector of a correlation matrix representative of the channel state information.

14. The wireless communication device of claim 1, wherein the beamformer is a two-dimensional beamformer that generates the plurality of coded data streams as two orthogonal data streams.

15. The wireless communication device of claim 1, wherein the wireless communication device comprises a mobile phone.

16. The wireless communication device of claim 1, wherein the wireless communication device comprises a base station.

17. A wireless communication device comprising:
a plurality of adaptive modulators to process respective streams of information bits, wherein each adaptive modulators comprises:
(i) a constellation selector that adaptively selects a signal constellation from a set of constellations based on channel state information for a wireless communication channel, wherein the constellation selector maps the respective information bits to symbols drawn from the selected constellation to produce a stream of symbols; and
(ii) a beamformer that generates a plurality of coded data streams from the stream of symbols; and
a modulator to produce a multi-carrier output waveform in accordance with the plurality of coded data streams for transmission through the wireless communication channel.

18. The wireless communication device of claim 17, further comprising a plurality of transmit antennas that output the multi-carrier waveform.

19. The wireless communication device of claim 17, wherein each adaptive modulator further comprises:
a power loader that processes the respective stream of information bits and loads additional information bits indicative of a power allocated to the respective stream of information bits,
wherein the respective constellation selector adaptively selects the signal constellation based on based on the additional information bits.

20. The wireless communication device of claim 19, wherein the power loader of the adaptive modulators loads the additional information bits based on the channel state information.

21. The wireless communication device of claim 17, wherein the constellation selectors of the adaptive modulators load additional information bits within the streams of information bits to indicate the selected constellations.

22. The wireless communication device of claim 21, wherein the constellation selectors of the adaptive modulators insert the additional bits by determining which of the streams of information bits are able to support each of the additional bits with the least required additional power.

23. The wireless communication device of claim 17, wherein the adaptive modulators jointly perform power and bit loading across the streams of information bits.

24. The wireless communication device of claim 17, wherein the constellation selectors of the adaptive modulators select the signal constellation for the respective stream of information bits based on partial information for the wireless communication channel.

25. The wireless communication device of claim 17, wherein the beamformer of each of the adaptive modulators comprise a space-time block coder that processes the respective stream of symbols from the constellation selector to generate space-time block coded data streams.

26. The wireless communication device of claim 25, wherein the beamformer of each of the adaptive modulators comprises a power splitter that controls a total power allocated across the space-time block coded data streams based on the channel information.

27. The wireless communication device of claim 25, wherein the beamformer of each of the adaptive modulators that applies an antenna weighting vector to the space-time coded data streams based on the channel state information to allocate a portion of each of the space-time coded data streams to each of the output antennas.

28. The wireless communication device of claim 17, wherein the wireless communication device comprises a mobile phone.

29. The wireless communication device of claim 17, wherein the wireless communication device comprises a base station

30. A method comprising:
receiving channel state information for a wireless communication system;
adaptively selecting a signal constellation from a set of constellations based on the channel state information; and
coding signals for transmission by a multiple antenna transmitter based on the estimated channel information and the selected constellation.

31. The method of claim 30, further comprising
mapping information bits of an outbound data stream to symbols drawn from the selected constellation to produce a stream of symbols;
generating a plurality of coded data streams from the stream of symbols to produce a plurality of coded signals; and
outputting waveforms from a plurality of transmit antennas in accordance with the plurality of coded data streams.

32. The method of claim 31, wherein adaptively selecting a signal constellation comprises adaptively selecting the signal constellation based at least in part on channel mean feedback received from a second wireless communication device.

33. The method of claim 30, wherein coding signals comprises forming Eigen-beams based on the channel state information.

34. The method of claim 30, wherein coding signals comprises processing the stream of symbols from the constellation selector to generate space-time block coded data streams.

35. The method of claim 34, further comprising applying a power splitter to controls a total power allocated across the space-time block coded data streams.

36. The method of claim 35, further comprising adjusting the power allocated to the space-time block coded streams based at least in part on the channel information.

37. The method of claim 35, further comprising adaptively adjusting allocation of total power across the space-time coded data streams as a function of the constellation that is selected by the constellation selector.

38. The method of claim 35, further comprising applying an antenna weighting vector to the space-time coded data streams to allocate a portion of each of the space-time coded data streams to each of the multiple antennas.

39. The method of claim 38, further comprising adjusting the antenna weighting vector based on the channel state information.

40. The method of claim 30, further comprising:
adaptively selecting a signal constellation from a set of constellations for each sub-carrier of a multi-carrier wireless communication system;
generating an outbound streams for each sub-carrier based on the selected constellations;
applying an eigen-beamformer to each of the streams of symbols to generate a plurality of coded data streams; and
applying modulators to produce a multi-carrier output waveform in accordance with the plurality of coded data streams for transmission through the multi-carrier wireless communication channel.

41. The method of claim 40, further comprising adaptively selecting a signal constellation for each subcarrier based on the power allocated to each subcarrier.

42. A computer-readable medium comprising instructions for causing a programmable processor of a wireless communication device to:
receive channel state information for a wireless communication system;
select a signal constellation from a set of constellations based on the channel state information;
map information bits of an outbound data stream to symbols drawn from the selected constellation to produce a stream of symbols; and
apply an eigen-beamformer to generate a plurality of coded data streams from the stream of symbols to produce a plurality of coded signals.
